(19) United States
(12) Patent Application Publication
(10) Pub. No.: US 2026/0304490 A1
(43) Pub. Date: Oct. 1, 2026

(54) METHOD AND DEVICE FOR TRANSMISSION AND RECEPTION OF RANDOM ACCESS PREAMBLE IN WIRELESS COMMUNICATION SYSTEM

(71) Applicant: LG ELECTRONICS INC., Seoul (KR)

(72) Inventors: Seokmin SHIN, Seoul (KR); Hyunsoo KO, Seoul (KR); Suckchel YANG, Seoul (KR); Yujin NOH, Seoul (KR); Seonwook KIM, Seoul (KR)

(73) Assignee: LG ELECTRONICS INC., Seoul (KR)

(21) Appl. No.: 19/471,632

(22) PCT Filed: Apr. 1, 2024
(86) PCT No.: PCT/KR2024/004192

§ 371 Date: Oct. 1, 2025

Related U.S. Application Data
(60) Provisional application No. 63/457,146, filed on Apr. 5, 2023.
(60) Provisional application No. 63/546,736, filed on Oct. 31, 2023.

(51) Int. Cl. H04W 74/0833; H04B 17/318

(52) U.S. Cl. CPC H04W 74/0833; H04B 17/328

(57) ABSTRACT

A method, according to one embodiment of the present specification, comprises the steps of: receiving a RACH configuration; and transmitting a random access preamble on the basis of a repetition number related to a feature combination. The RACH configuration includes a plurality of preamble configurations. Each of the plurality of preamble configurations is related to one feature combination. The repetition number is one from among a plurality of repetition numbers based on the plurality of preamble configurations.

### TECHNICAL FIELD

The present disclosure relates to a device and method for transmitting and receiving a random access preamble in a wireless communication system.

### BACKGROUND

Mobile communication systems have been developed to guarantee user activity while providing voice services. Mobile communication systems are expanding their services from voice only to data. Current soaring data traffic is depleting resources and users' demand for higher-data rate services is leading to the need for more advanced mobile communication systems.

Next-generation mobile communication systems are required to meet, e.g., handling of explosively increasing data traffic, significant increase in per-user transmission rate, working with a great number of connecting devices, and support for very low end-to-end latency and high-energy efficiency. To that end, various research efforts are underway for various technologies, such as dual connectivity, massive multiple input multiple output (MIMO), in-band full duplex, non-orthogonal multiple access (NOMA), super wideband support, and device networking.

According to an Rel-17 feature combination, only one feature can be configured or a combination of a plurality of features can be configured in specific RACH resource partitioning. In Rel-18, a feature related to repetition of MSG1 is supported. In this instance, the repetition number (2, 4, or 8) may be set. In this case, among preamble indices, only one repetition number may be set/applied to preamble indices to which the MSG1 repetition feature is applied.

### DISCLOSURE

### Technical Problem

It may be inefficient to use a fixed repetition number for all preambles to which the above-described MSG1 repetition feature is applied.

The present disclosure proposes a method for solving the problem described above.

The technical objects of the present disclosure are not limited to the aforementioned technical objects, and other technical objects, which are not mentioned above, will be apparently appreciated by a person having ordinary skill in the art from the following description.

### Technical Solution

A method performed by a user equipment (UE) according to an embodiment of the present disclosure comprises receiving a Random Access CHannel (RACH) configuration, and transmitting a random access preamble based on a repetition number related to a feature combination.

The RACH configuration includes a plurality of preamble configurations. Each of the plurality of preamble configurations is related to one feature combination. The repetition number is one of a plurality of repetition numbers based on the plurality of preamble configurations.

The repetition number may be determined based on a Reference Signal Received Power (RSRP) among the plurality of repetition numbers.

The RACH configuration may include RACH configurations based on a BandWidth Part (BWP)-uplink common configuration.

The RACH configurations may include i) a RACH configuration in the BWP-uplink common configuration and ii) a RACH configuration based on each additional RACH configuration in the BWP-uplink common configuration.

Each preamble configuration based on the RACH configurations may include information for a set of preambles. On a bandwidth part (BWP), a set of preambles associated with each of the plurality of repetition numbers may be at most one.

The plurality of repetition numbers may be based on different values.

One or more features may be indicated based on the feature combination. The one or more features may include MSG1 repetitions.

The plurality of repetition numbers may be configured based on preamble configurations including a feature combination related to the MSG1 repetitions.

The plurality of repetition numbers may be related to a shared RACH occasion (RO).

The repetition number may be 2, 4 or 8.

A user equipment (UE) according to another embodiment of the present disclosure comprises one or more transceivers, one or more processors, and one or more memories connected to the one or more processors and configured to store instructions.

The instructions, based on being executed by the one or more processors, configure the one or more processors to perform all steps of any one of the methods.

A device according to another embodiment of the present disclosure comprises one or more memories and one or more processors operably connected to the one or more memories.

The one or more memories are configured to store instructions based on being executed by the one or more processors, and the instructions are configured to allow the one or more processors to perform all steps of any one of the methods.

One or more non-transitory computer readable mediums according to another embodiment of the present disclosure stores instructions. The instructions executable by one or more processors are configured to allow the one or more processors to perform all steps of any one of the methods.

A method performed by a base station according to another embodiment of the present disclosure comprises transmitting a Random Access CHannel (RACH) configuration, and receiving a random access preamble based on a repetition number related to a feature combination.

The RACH configuration includes a plurality of preamble configurations. Each of the plurality of preamble configurations is related to one feature combination. The repetition number is one of a plurality of repetition numbers based on the plurality of preamble configurations.

A base station according to another embodiment of the present disclosure comprises one or more transceivers, one or more processors, and one or more memories connected to the one or more processors and storing instructions.

The instructions configure the one or more processors to perform all steps of the methods based on being executed by the one or more processors.

### Advantageous Effects

According to embodiments of the present disclosure, a random access preamble can be performed based on one of multiple repetition numbers. Accordingly, since various repetition numbers can be supported for the same feature (MSG1 repetition), repetition transmission of the random access preamble can be performed based on a repetition number most suitable for the channel quality.

In addition, signaling overhead of a RACH procedure can be reduced compared to when a fixed repetition number is configured/used. For example, if the repetition transmission of the random access preamble is performed based on many repetition numbers even in good channel conditions, unnecessary signaling overhead is caused. According to embodiments of the present disclosure, since the repetition transmission can be performed based on a repetition number suitable for the channel conditions, the RACH procedure can be improved in terms of signaling overhead.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

FIG. 1 illustrates physical channels and general signal transmission used in a 3GPP system.

FIG. 2 illustrates RACH occasions for each preamble format.

FIG. 3 illustrates a random access procedure.

FIG. 4 illustrates an RACH partitioning related RRC parameter.

FIGS. 5 to 9 illustrate configuration of a repetition number based on additional RACH configuration.

FIGS. 10 to 15 illustrate configuration of a repetition number based on a feature combination.

FIG. 16 is a flowchart illustrating a method performed by a user equipment (UE) according to an embodiment of the present disclosure.

FIG. 17 is a flowchart illustrating a method performed by a base station (BS) according to another embodiment of the present disclosure.

FIG. 18 illustrates configurations of a first device and a second device according to an embodiment of the present disclosure.

### DETAILED DESCRIPTION

Hereinafter, preferred embodiments of the disclosure are described in detail with reference to the accompanying drawings. The following detailed description taken in conjunction with the accompanying drawings is intended for describing example embodiments of the disclosure, but not for representing a sole embodiment of the disclosure. The detailed description below includes specific details to convey a thorough understanding of the disclosure. However, it will be easily appreciated by one of ordinary skill in the art that embodiments of the disclosure may be practiced even without such details.

In some cases, to avoid ambiguity in concept, known structures or devices may be omitted or be shown in block diagrams while focusing on core features of each structure and device.

Hereinafter, downlink (DL) means communication from a base station to a terminal and uplink (UL) means communication from the terminal to the base station. In the downlink, a transmitter may be part of the base station, and a receiver may be part of the terminal. In the uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

### Physical Channel and General Signal Transmission

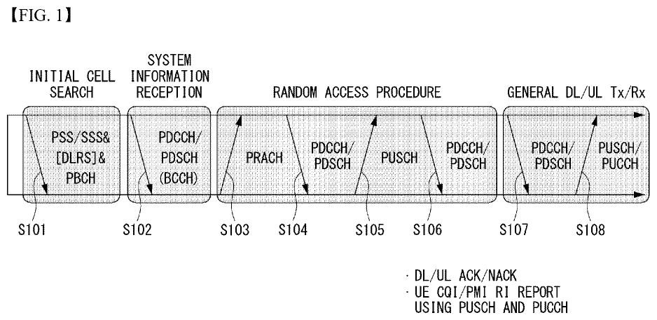

FIG. 1 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S101). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. The UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S102).

When there is no radio resource first accessing the eNB or for signal transmission, the UE may perform a Random Access Procedure (RACH) to the eNB (S103 to S106). To this end, the UE may transmit a specific sequence to a preamble through a Physical Random Access Channel (PRACH) (S103 and S105) and receive a response message (Random Access Response (RAR) message) for the preamble through the PDCCH and a corresponding PDSCH. In the case of a contention based RACH, a Contention Resolution Procedure may be additionally performed (S106).

The UE that performs the above procedure may then perform PDCCH/PDSCH reception (S107) and Physical Uplink Shared Channel (PUSCH)/Physical Uplink Control Channel (PUCCH) transmission (S108) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

The control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

An RACH slot is described below.

An RACH slot includes one or multiple RACH Occasion(s).

Slot duration is 1 ms for {1.25 kHz, 5 kHz} subcarrier spacing, and has scalable duration (i.e., 1 ms, 0.5 ms, 0.25 ms, 0.125 ms) for {15 kHz, 30 kHz, 60 kHz, 120 kHz} subcarrier spacing.

A start OFDM symbol index in an RACH slot has {0,2,x} values for short preamble formats.

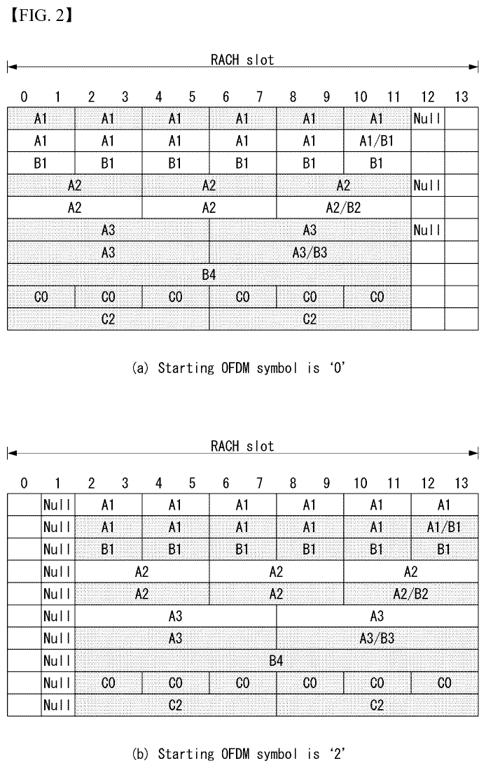

FIG. 2 illustrates RACH occasions for each preamble format.

Referring to FIG. 2, an RACH slot may include one or more RACH occasions (ROs) for each preamble format (e.g., A1, A2, . . . , C2). (a) of FIG. 2 illustrates a case in which a starting OFDM symbol is ‘0’, and (b) of FIG. 2 illustrates a case in which a starting OFDM symbol is ‘2’.

FIG. 3 illustrates a random access procedure.
(a) of FIG. 3 illustrates a contention based RACH procedure, and (b) of FIG. 3 illustrates a contention free RACH procedure.

MSG1 transmission is described below.

Subcarrier spacing for MSG1 is configured in an RACH configuration, and is provided in a handover command with respect to a contention-free RA procedure for handover.

Preamble indices for contention-based random access (CBRA) and contention-free random access (CFRA) are consecutively mapped to one SSB in one RACH transmission occasion.
CBRA: Association between an SS block (SSB) within an SS burst set and a subset of RACH resources and/or preamble indices is configured by a parameter set in an RMSI.
CFRA: A UE may be configured transmit multi-MSG1s through a dedicated multi-RACH transmission occasion in the time domain before the end of a monitored RAR window.

Furthermore, association between a CFRA preamble and an SSB is reconfigured through UE-specific RRC.

The random access procedure may be a Type-1 random access procedure (4-step RA) or a Type-2 random access procedure (2-step RA).

The Type-1 random access procedure may include transmission of random access preamble in a physical random access channel (PRACH) (Msg1), reception of a random access response (RAR) (Msg2), transmission of PUSCH scheduled by UL grant of the RAR (Msg3), and PDSCH for contention resolution (Msg4). If the random access procedure is contention free random access (CFRA), the Msg3 transmission and the Msg4 reception are omitted.

The Type-2 random access procedure may include transmission of random access preamble and PUSCH (MsgA) and RAR reception (MsgB).

The following Table 1 shows configurations/operations related to the random access preamble.

```
TABLE 1
8.1 Random access preamble
Physical random access procedure for a UE is triggered upon request of a PRACH
transmission by higher layers or by a PDCCH order for a cell. A configuration by
higher layers for a PRACH transmission includes the following:
    - A configuration for PRACH transmission on the cell [4, TS 38.211].
    - A preamble index, a preamble SCS, P_{PRACH, target}, a corresponding RA-
      RNTI when applicable [11, TS 38.321], and a PRACH resource for the cell.
  $- A number of {N}_{preamble}^{rep} > 1 preamble repetitions for the PRACH$
      transmission if the UE would transmit the PRACH with repetitions.
A UE transmits a PRACH on a cell using the selected PRACH format with
transmission power P_{PRACH,b,f,c}(i), as described in clause 7.4, on the indicated
$PRACH resource or on a determined set of {N}_{preamble}^{rep} resources using a same$
$spatial filter in case {N}_{preamble}^{rep} preamble repetitions .$
For Type-1 random access procedure, a UE is provided a number N of SS/PBCH
block indexes associated with one PRACH occasion and a number R of contention
based preambles per SS/PBCH block index per valid PRACH occasion by ssb-
perRACH-OccasionAndCB-PreamblesPerSSB.
For Type-2 random access procedure with common configuration of PRACH
occasions with Type-1 random access procedure, a UE is provided a number N of
SS/PBCH block indexes associated with one PRACH occasion by ssb-perRACH-
OccasionAndCB-PreamblesPerSSB and a number Q of contention based
preambles per SS/PBCH block index per valid PRACH occasion by msgA-CB-
PreamblesPerSSB-PerSharedRO. The PRACH transmission can be on a subset of
PRACH occasions associated with a same SS/PBCH block index within an SSB-
RO mapping cycle for a UE provided with a PRACH mask index by msgA-SSB-
SharedRO-MaskIndex according to [11, TS 38.321].
For Type-2 random access procedure with separate configuration of PRACH
occasions with Type-1 random access procedure, a UE is provided a number N of
SS/PBCH block indexes associated with one PRACH occasion and a number R of
contention based preambles per SS/PBCH block index per valid PRACH occasion
by msgA-SSB-PerRACH-OccasionAndCB-PreamblesPerSSB when provided;
otherwise, by ssb-perRACH-OccasionAndCB-PreamblesPerSSB.
For a random access procedure associated with a feature combination indicated by
FeatureCombinationPreambles, a UE is provided a number N of SS/PBCH block
indexes associated with one PRACH occasion by ssb-perRACH-OccasionAndCB-
PreamblesPerSSB or msgA-SSB-PerRACH-OccasionAndCB-PreamblesPerSSB
when provided and a number S of contention based preambles per SS/PBCH block
index per valid PRACH occasion by startPreambleForThisPartition and
numberOfPreamblesPerSSB-ForThisPartition. The PRACH transmission can be
on a subset of PRACH occasions associated with a same SS/PBCH block index
within an SSB-RO mapping cycle for a UE provided with a PRACH mask index
by ssb-SharedRO-MaskIndex according to [11, TS 38.321].
For Type-1 random access procedure, or for Type-2 random access procedure with
separate configuration of PRACH occasions from Type 1 random access
procedure, if N < 1, one SS/PBCH block index is mapped to 1/N consecutive
valid PRACH occasions and R contention
based preambles with consecutive indexes associated with the SS/PBCH block
index per valid PRACH occasion start from preamble index 0. If N ≥ 1, R
contention based preambles with consecutive indexes associated with SS/PBCH
block index n, 0 ≤ n ≤ N - 1, per valid PRACH occasion start from preamble
$index n \cdot {N}_{preamble}^{total} / N where {N}_{preamble}^{total} is provided by totalNumberOfRA -$
Preambles for Type-1 random access procedure, or by msgA-TotalNumberOfRA-
Preambles for Type-2 random access procedure with separate configuration of
PRACH occasions from a Type 1 random access procedure, and is an integer
multiple of N.
For Type-2 random access procedure with common configuration of PRACH
occasions with Type-1 random access procedure, if N < 1, one SS/PBCH block
index is mapped to 1/N consecutive valid PRACH occasions and Q contention
based preambles with consecutive indexes associated with the SS/PBCH block
index per valid PRACH occasion start from preamble index R. If N ≥ 1, Q
contention based preambles with consecutive indexes associated with SS/PBCH
block index n, 0 ≤ n ≤ N - 1, per valid PRACH occasion start from preamble
$index n \cdot {N}_{preamble}^{total} / N + R , where {N}_{preamble}^{total} is provided by totalNumberOfRA -$
Preambles for Type-1 random access procedure.
For link recovery, a UE is provided N SS/PBCH block indexes associated with
one PRACH occasion by ssb-perRACH-Occasion in BeamFailureRecoveryConfig.
For a dedicated RACH configuration provided by RACH-ConfigDedicated, if cfra
is provided, a UE is provided N SS/PBCH block indexes associated with one
PRACH occasion by ssb-perRACH-Occasion in occasions. If N < 1, one
SS/PBCH block index is mapped to 1/N consecutive valid PRACH occasions. If
N ≥ 1, all consecutive N SS/PBCH block indexes are associated with one
PRACH occasion.
SS/PBCH block indexes provided by ssb-PositionsInBurst in SIB1 or in
ServingCellConfigCommon are mapped to valid PRACH occasions in the
following order where the parameters are described in [4, TS 38.211].
      - First, in increasing order of preamble indexes within a single PRACH
        occasion
      - Second, in increasing order of frequency resource indexes for frequency
        multiplexed PRACH occasions
      - Third, in increasing order of time resource indexes for time multiplexed
        PRACH occasions within a PRACH slot
      - Fourth, in increasing order of indexes for PRACH slots
An association period, starting from frame 0, for mapping SS/PBCH block indexes
to PRACH occasions is the smallest integer number in the set determined by the
$PRACH configuration period according Table 8.1 - 1 such that {N}_{Tx}^{SSB} SS / PBCH block$
indexes are mapped at least once to the PRACH occasions within the association
$period , where a UE obtains {N}_{Tx}^{SSB} from the value of ssb - PositionsInBurst in SIB 1 or$
in ServingCellConfigCommon. If after an integer number of SS/PBCH block
indexes to PRACH occasions mapping cycles within the association period there is
$a set of PRACH occasions or PRACH preambles that are not mapped to {N}_{Tx}^{SSB}$
SS/PBCH block indexes, no SS/PBCH block indexes are mapped to the set of
PRACH occasions or PRACH preambles. An association pattern period includes
one or more association periods and is determined so that a pattern between PRACH
occasions and SS/PBCH block indexes repeats at most every 160 msec.
PRACH occasions not associated with SS/PBCH block indexes after an integer
number of association periods, if any, are not used for PRACH transmissions.
For a PRACH transmission by a UE triggered by a PDCCH order, the PRACH
mask index field, if the value of the random access preamble index field is not
zero, indicates the PRACH occasion for the PRACH transmission where the
PRACH occasions are associated with the SS/PBCH block index indicated by the
SS/PBCH block index field of the PDCCH order and, if any, a cell indicator field
indicates a cell for the PRACH transmission [5, TS 38.212]. If the UE is provided
K_{cell,offset} by cellSpecificKoffset, the PRACH occasion is after slot n +
2^{μ}. K_{cell,offset} where n is the slot of the UL BWP for the PRACH transmission
that overlaps with the end of the PDCCH order reception assuming T_{TA} = 0, and μ
is the SCS configuration for the PRACH transmission. If the PDCCH reception for
the PDCCH order includes two PDCCH candidates from two linked search space
sets based on searchSpaceLinkingld, as described in clause 10.1, the last symbol
of the PDCCH reception is the last symbol of the PDCCH candidate that ends
later. The PDCCH reception includes the two PDCCH candidates also when the
UE is not required to monitor one of the two PDCCH candidates as described in
clauses 10 (except clause 10.4), 11.1, 11.1.1 and 17.2.
For a PRACH transmission triggered by higher layers, if ssb-ResourceList is
provided, the PRACH mask index is indicated by ra-ssb-OccasionMaskIndex
which indicates the PRACH occasions for the PRACH transmission where the
PRACH occasions are associated with the selected SS/PBCH block index.
The PRACH occasions are mapped consecutively per corresponding SS/PBCH
block index. The indexing of the PRACH occasion indicated by the mask index
value is reset per mapping cycle of consecutive PRACH occasions per SS/PBCH
block index. The UE selects for a PRACH transmission the PRACH occasion
indicated by PRACH mask index value for the indicated SS/PBCH block index in
the first available mapping cycle.
For the indicated preamble index, the ordering of the PRACH occasions is
      - First, in increasing order of frequency resource indexes for frequency
        multiplexed PRACH occasions
      - Second, in increasing order of time resource indexes for time multiplexed
        PRACH occasions within a PRACH slot
      - Third, in increasing order of indexes for PRACH slots
$For a PRACH transmission with {N}_{preamble}^{rep} preamble repetitions , a set consists of$
${N}_{preamble}^{rep} valid PRACH occasions that are consecutive in time , use same$
frequency resources, and are associated with same one or more SS/PBCH block
index(es), and each SS/PBCH block index is associated with same preamble
indexes in all valid PRACH occasions within the set.
For a PRACH transmission with preamble repetitions, a time period, starting from
frame 0, is the smallest integer number of association pattern periods such that at
$least one set of valid PRACH occasions for each of the {N}_{Tx}^{SSB} SS / PBCH block$
indexes can be determined within the time period for all configured number of
preamble repetitions. The set(s) of valid PRACH occasions for each configured
number of preamble repetitions repeats every time period.
$Wihin a time period , for set ( s ) of {N}_{preamble}^{rep} valid PRACH occasions for a$
$PRACH transmission with {N}_{preamble}^{rep} preamble repetitions$
      - the first valid PRACH occasion of the first set is the first valid PRACH
        occasion
      - the first valid PRACH occasion of subsequent sets, if any, is determined
        according to an ordering of valid PRACH occasions
        - first, in increasing order of frequency resource indexes for frequency
          multiplexed PRACH occasions
      - second, in increasing order of time resource indexes for time multiplexed
        PRACH occasions
where, for each frequency resource index for frequency multiplexed PRACH
occasions
      - the first valid PRACH occasion of the first set is the first valid PRACH
        occasion
      - the first valid PRACH occasion of subsequent sets, if any,
        - is after TimeOffsetBetweenStartingRO consecutive valid PRACH
          occasions in time from the first valid PRACH occasion of the previous
          set, where each PRACH occasion is associated with same SS/PBCH
          block index(es) and each SS/PBCH block index is associated with same
          preambles, if TimeOffsetBetweenStartingRO is provided
        - is after the PRACH occasions for the previous set, if
          Time OffsetBetweenStartingRO is not provided
For a PRACH transmission triggered upon request by higher layers, a value of ra-
OccasionList [12, TS 38.331], if csirs-ResourceList is provided, indicates a list of
PRACH occasions for the PRACH transmission where the PRACH occasions are
associated with the selected CSI-RS index indicated by csi-RS. The indexing of
the PRACH occasions indicated by ra-OccasionList is reset per association pattern period.
```

TABLE 8.1-1
Mapping between PRACH configuration period and SS/PBCH block to PRACH occasion association period

| PRACH configuration period | Association period (number of |
|---|---|
| (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

For paired spectrum or supplementary uplink band all PRACH occasions are valid.
For unpaired spectrum,

| | |
|---|---|
| - | if a UE is not provided tdd-UL-DL-ConfigurationCommon, a PRACH |
| | occasion in a PRACH slot is valid if it does not precede a SS/PBCH block in |
| | the PRACH slot and starts at least N_{gap} symbols after a last SS/PBCH block |
| | reception symbol, where N_{gap} is |

provided in Table 8.1-2 and, if channelAccessMode = “semiStatic” is provided,

| | does not overlap with a set of consecutive symbols before the start of a next | |
|---|---|---|
| | channel occupancy time where the UE does not transmit [15, TS 37.213]. | |
| | - | the candidate SS/PBCH block index of the SS/PBCH block corresponds |
| | | to the SS/PBCH block index provided by ssb-PositionsInBurst in SIB1 or |
| | | in ServingCellConfigCommon, as described in clause 4.1 |
| - | If a UE is provided tdd-UL-DL-ConfigurationCommon, a PRACH occasion | |
| | in a PRACH slot is valid if | |
| | - | it is within UL symbols, or |
| | - | it does not precede a SS/PBCH block in the PRACH slot and starts at |
| | | least N_{gap} symbols after a last downlink symbol and at least N_{gap} |
| | | symbols after a last SS/PBCH block symbol, where N_{gap} is provided in |
| | | Table 8.1-2, and if channelAccessMode = “semiStatic” is provided, does |
| | | not overlap with a set of consecutive symbols before the start of a next |
| | | channel occupancy time where there shall not be any transmissions, as |
| | | described in [15, TS 37.213] |

| | |
|---|---|
| - | the candidate SS/PBCH block index of the SS/PBCH block |
| | corresponds to the SS/PBCH block index provided by ssb- |
| | PositionsInBurst in SIB1 or in ServingCellConfigCommon, as |
| | described in clause 4.1. |

For preamble format B4 [4, TS 38.211], N_{gap} = 0.

TABLE 8.1-2
N_{gap} values for different preamble SCS μ

| Preamble SCS | N_{gap} |
|---|---|
| 1.25 kHz or 5 kHz | 0 |
| 15 kHz or 30 kHz or 60 kHz or | 2 |
| 120 kHz | |
| 480 kHz | 8 |
| 960 kHz | 16 |

```
If a random access procedure is initiated by a PDCCH order, the UE, if requested
by higher layers, transmits a PRACH in the selected PRACH occasion, as
described in [11, TS 38.321], for which a time between the last symbol of the
PDCCH order reception and the first symbol of the PRACH transmission is larger
than or equal to N_{T,2} + T_{BWPswitchDelay} + Δ_{Delay} + T_{switch} + T_{SSB} +
Δ_{RF/BB} preparation msec, where
  - N_{T,2} is a time duration of N₂ symbols corresponding to a PUSCH
      preparation time for UE processing capability 1 [6, TS 38.214] assuming μ
      corresponds to the smallest SCS configuration between the SCS
      configuration of the PDCCH order and the SCS configuration of the
      corresponding PRACH transmission
  - T_{BWPswitchDelay} = 0 if the active UL BWP does not change, or if a cell
      indicator field in the PDCCH order indicates a non-serving cell [5, TS
      38.212], and T_{BWPswitchDelay} is defined in [10, TS 38.133] otherwise
  - Δ_{Delay} = 0.5 msec for FR1 and Δ_{Delay} = 0.25 msec for FR2
  - T_{switch} is a switching gap durtation as defined in [6, TS 38.214]
  - T_{SSB} = 0 if a cell indicator field in the PDCCH order indicates a serving cell
      or if cell indicator field is not present, and T_{SSB} is defined in [10, TS 38.133]
      otherwise
  - Δ_{RF/BB preparation} = 0 if a cell indicator field in the PDCCH order indicates a
      serving cell or if cell indicator field is not present, and Δ_{RF/BB preparation} is
      defined in [10, TS 38.133] otherwise
For a PRACH transmission using 1.25 kHz or 5 kHz SCS, the UE determines N₂
assuming SCS configuration μ = 0.
For single cell operation or for operation with contiguous carrier aggregation in a
same frequency band or for operation with non-contiguous carrier aggregation in a
same frequency band if the UE is not provided with intraBandNC-PRACH-
simulTx-r17, a UE
  - does not transmit PRACH and PUSCH/PUCCH/SRS in a same slot with
      respect to the smallest SCS configuration between the SCS configuration for
      the UL BWP with the PRACH and the SCS configuration for the UL BWP
      with the PUSCH/PUCCH/SRS transmissions,
  - does not transmit PRACH and PUSCH/PUCCH/SRS when a first or last
      symbol of a PRACH transmission in a first slot is separated by less than N
      symbols from the last or first symbol, respectively, of a
      PUSCH/PUCCH/SRS transmission in a second slot
  $‐ for a PRACH transmission with {N}_{preamble}^{rep} > 1 preamble repetitions , if the$
      UE does not indicate capability-XYZ, the UE does not transmit a first
      repetition of the PRACH and a second repetition of the PRACH when a first
      or last symbol of the first repetition of the PRACH in a first slot is separated
      by less than N symbols from the last or first symbol, respectively, of the
      second repetition of the PRACH in a second slot; otherwise, the UE
      transmits the first repetition of the PRACH and the second repetition of the
      PRACH
where N = 2 for μ = 0 or μ =1, N = 4 for μ = 2 or μ = 3, N = 16 for μ = 5,
N = 32 for μ = 6, and μ is the smallest SCS configuration between the SCS
configuration for the UL BWP with the PRACH and the SCS configuration for the
UL BWP with the PUSCH/PUCCH/SRS transmissions. For a PUSCH
transmission with repetition Type B, this applies to each actual repetition for
PUSCH transmission [6, TS 38.214].
```

The configurations/definitions/operations according to Table 1 above may be referred to in order to clarify definitions/operations of embodiments to be described below. As an example, in an embodiment to be described below, ROs may refer to the valid PRACH occasions mentioned in Table 1. As an example, in an embodiment to be described below, multiple ROs having a same beam index may mean 1/N (where, N<1) consecutive valid PRACH occasions to which one SS/PBCH index is mapped.

Tables 2 to 4 below illustrate PRACH configuration tables to which the embodiments to be described below may be applied.

TABLE 2
Table 6.3.3.2-2: Random access configurations for FR1 and paired
spectrum/supplementary uplink.

| | | | | | | | N_{RA,slot} | |
|---|---|---|---|---|---|---|---|---|
| | | | | | | | number | |
| | | | | | | | of | |
| | | | | | | | time- | |
| | | | | | | | domain | |
| | | | | | | Number | PRACH | |
| | | | | | | of | ccasions | |
| PRACH Configu- | | | | | | PRACH slots | within a | ${N}_{dur}^{RA} ,$ |
| ration | Preamble | NSFN modx = y | | Subframe | Starting | within a | PRACH | PRACH |
| index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| 11 | 0 | 4 | 1 | 9 | 0 | — | — | 0 |
| 12 | 0 | 2 | 1 | 1 | 0 | — | — | 0 |
| 13 | 0 | 2 | 1 | 4 | 0 | — | — | 0 |
| 14 | 0 | 2 | 1 | 7 | 0 | — | — | 0 |
| 15 | 0 | 2 | 1 | 9 | 0 | — | — | 0 |
| 16 | 0 | 1 | 0 | 1 | 0 | — | — | 0 |
| 17 | 0 | 1 | 0 | 4 | 0 | — | — | 0 |
| 18 | 0 | 1 | 0 | 7 | 0 | — | — | 0 |
| 19 | 0 | 1 | 0 | 1, 6 | 0 | — | — | 0 |
| 20 | 0 | 1 | 0 | 2, 7 | 0 | — | — | 0 |
| 21 | 0 | 1 | 0 | 3, 8 | 0 | — | — | 0 |
| 22 | 0 | 1 | 0 | 1, 4, 7 | 0 | — | — | 0 |
| 23 | 0 | 1 | 0 | 2, 5, 8 | 0 | — | — | 0 |
| 24 | 0 | 1 | 0 | 3, 6, 9 | 0 | — | — | 0 |
| 25 | 0 | 1 | 0 | 0, 2, 4, 6, 8 | 0 | — | — | 0 |
| 26 | 0 | 1 | 0 | 1, 3, 5, 7, 9 | 0 | — | — | 0 |
| 27 | 0 | 1 | 0 | 0, 1, 2, 3, 4, | 0 | — | — | 0 |
| | | | | 5, 6, 7, 8, 9 | | | | |
| 28 | 1 | 16 | 1 | 1 | 0 | — | — | 0 |
| 29 | 1 | 16 | 1 | 4 | 0 | — | — | 0 |
| 30 | 1 | 16 | 1 | 7 | 0 | — | — | 0 |
| 31 | 1 | 16 | 1 | 9 | 0 | — | — | 0 |
| 32 | 1 | 8 | 1 | 1 | 0 | — | — | 0 |
| 33 | 1 | 8 | 1 | 4 | 0 | — | — | 0 |
| 34 | 1 | 8 | 1 | 7 | 0 | — | — | 0 |
| 35 | 1 | 8 | 1 | 9 | 0 | — | — | 0 |
| 36 | 1 | 4 | 1 | 1 | 0 | — | — | 0 |
| 37 | 1 | 4 | 1 | 4 | 0 | — | — | 0 |
| 38 | 1 | 4 | 1 | 7 | 0 | — | — | 0 |
| 39 | 1 | 4 | 1 | 9 | 0 | — | — | 0 |
| 40 | 1 | 2 | 1 | 1 | 0 | — | — | 0 |
| 41 | 1 | 2 | 1 | 4 | 0 | — | — | 0 |
| 42 | 1 | 2 | 1 | 7 | 0 | — | — | 0 |
| 43 | 1 | 2 | 1 | 9 | 0 | — | — | 0 |
| 44 | 1 | 1 | 0 | 1 | 0 | — | — | 0 |
| 45 | 1 | 1 | 0 | 4 | 0 | — | — | 0 |
| 46 | 1 | 1 | 0 | 7 | 0 | — | — | 0 |
| 47 | 1 | 1 | 0 | 1, 6 | 0 | — | — | 0 |
| 48 | 1 | 1 | 0 | 2, 7 | 0 | — | — | 0 |
| 49 | 1 | 1 | 0 | 3, 8 | 0 | — | — | 0 |
| 50 | 1 | 1 | 0 | 1, 4, 7 | 0 | — | — | 0 |
| 51 | 1 | 1 | 0 | 2, 5, 8 | 0 | — | — | 0 |
| 52 | 1 | 1 | 0 | 3, 6, 9 | 0 | — | — | 0 |
| 53 | 2 | 16 | 1 | 1 | 0 | — | — | 0 |
| 54 | 2 | 8 | 1 | 1 | 0 | — | — | 0 |
| 55 | 2 | 4 | 0 | 1 | 0 | — | — | 0 |
| 56 | 2 | 2 | 0 | 1 | 0 | — | — | 0 |
| 57 | 2 | 2 | 0 | 5 | 0 | — | — | 0 |
| 58 | 2 | 1 | 0 | 1 | 0 | — | — | 0 |
| 59 | 2 | 1 | 0 | 5 | 0 | — | — | 0 |
| 60 | 3 | 16 | 1 | 1 | 0 | — | — | 0 |
| 61 | 3 | 16 | 1 | 4 | 0 | — | — | 0 |
| 62 | 3 | 16 | 1 | 7 | 0 | — | — | 0 |
| 63 | 3 | 16 | 1 | 9 | 0 | — | — | 0 |
| 64 | 3 | 8 | 1 | 1 | 0 | — | — | 0 |
| 65 | 3 | 8 | 1 | 4 | 0 | — | — | 0 |
| 66 | 3 | 8 | 1 | 7 | 0 | — | — | 0 |
| 67 | 3 | 4 | 1 | 1 | 0 | — | — | 0 |
| 68 | 3 | 4 | 1 | 4 | 0 | — | — | 0 |
| 69 | 3 | 4 | 1 | 7 | 0 | — | — | 0 |
| 70 | 3 | 4 | 1 | 9 | 0 | — | — | 0 |
| 71 | 3 | 2 | 1 | 1 | 0 | — | — | 0 |
| 72 | 3 | 2 | 1 | 4 | 0 | — | — | 0 |
| 73 | 3 | 2 | 1 | 7 | 0 | — | — | 0 |
| 74 | 3 | 2 | 1 | 9 | 0 | — | — | 0 |
| 75 | 3 | 1 | 0 | 1 | 0 | — | — | 0 |
| 76 | 3 | 1 | 0 | 4 | 0 | — | — | 0 |
| 77 | 3 | 1 | 0 | 7 | 0 | — | — | 0 |
| 78 | 3 | 1 | 0 | 1, 6 | 0 | — | — | 0 |
| 79 | 3 | 1 | 0 | 2, 7 | 0 | — | — | 0 |
| 80 | 3 | 1 | 0 | 3, 8 | 0 | — | — | 0 |
| 81 | 3 | 1 | 0 | 1, 4, 7 | 0 | — | — | 0 |
| 82 | 3 | 1 | 0 | 2, 5, 8 | 0 | — | — | 0 |
| 83 | 3 | 1 | 0 | 3, 6, 9 | 0 | — | — | 0 |
| 84 | 3 | 1 | 0 | 0, 2, 4, 6, 8 | 0 | — | — | 0 |
| 85 | 3 | 1 | 0 | 1, 3, 5, 7, 9 | 0 | — | — | 0 |
| 86 | 3 | 1 | 0 | 0, 1, 2, 3, 4, | 0 | — | — | 0 |
| | | | | 5, 6, 7, 8, 9 | | | | |
| 87 | A1 | 16 | 0 | 4, 9 | 0 | 1 | 6 | 2 |
| 88 | A1 | 16 | 1 | 4 | 0 | 2 | 6 | 2 |
| 89 | A1 | 8 | 0 | 4, 9 | 0 | 1 | 6 | 2 |
| 90 | A1 | 8 | 1 | 4 | 0 | 2 | 6 | 2 |
| 91 | A1 | 4 | 0 | 4, 9 | 0 | 1 | 6 | 2 |
| 92 | A1 | 4 | 1 | 4, 9 | 0 | 1 | 6 | 2 |
| 93 | A1 | 4 | 0 | 4 | 0 | 2 | 6 | 2 |
| 94 | A1 | 2 | 0 | 4, 9 | 0 | 1 | 6 | 2 |
| 95 | A1 | 2 | 0 | 1 | 0 | 2 | 6 | 2 |
| 96 | A1 | 2 | 0 | 4 | 0 | 2 | 6 | 2 |
| 97 | A1 | 2 | 0 | 7 | 0 | 2 | 6 | 2 |
| 98 | A1 | 1 | 0 | 4 | 0 | 1 | 6 | 2 |
| 99 | A1 | 1 | 0 | 1, 6 | 0 | 1 | 6 | 2 |
| 100 | A1 | 1 | 0 | 4, 9 | 0 | 1 | 6 | 2 |
| 101 | A1 | 1 | 0 | 1 | 0 | 2 | 6 | 2 |
| 102 | A1 | 1 | 0 | 7 | 0 | 2 | 6 | 2 |
| 103 | A1 | 1 | 0 | 2, 7 | 0 | 2 | 6 | 2 |
| 104 | A1 | 1 | 0 | 1, 4, 7 | 0 | 2 | 6 | 2 |
| 105 | A1 | 1 | 0 | 0, 2, 4, 6, 8 | 0 | 2 | 6 | 2 |
| 106 | A1 | 1 | 0 | 0, 1, 2, 3, 4, | 0 | 2 | 6 | 2 |
| | | | | 5, 6, 7, 8, 9 | | | | |
| 107 | A1 | 1 | 0 | 1, 3, 5, 7, 9 | 0 | 2 | 6 | 2 |
| 108 | A1/B1 | 2 | 0 | 4, 9 | 0 | 1 | 7 | 2 |
| 109 | A1/B1 | 2 | 0 | 4 | 0 | 2 | 7 | 2 |
| 110 | A1/B1 | 1 | 0 | 4 | 0 | 1 | 7 | 2 |
| 111 | A1/B1 | 1 | 0 | 1, 6 | 0 | 1 | 7 | 2 |
| 112 | A1/B1 | 1 | 0 | 4, 9 | 0 | 1 | 7 | 2 |
| 113 | A1/B1 | 1 | 0 | 1 | 0 | 2 | 7 | 2 |
| 114 | A1/B1 | 1 | 0 | 7 | 0 | 2 | 7 | 2 |
| 115 | A1/B1 | 1 | 0 | 1, 4, 7 | 0 | 2 | 7 | 2 |
| 116 | A1/B1 | 1 | 0 | 0, 2, 4, 6, 8 | 0 | 2 | 7 | 2 |
| 117 | A2 | 16 | 1 | 2, 6, 9 | 0 | 1 | 3 | 4 |
| 118 | A2 | 16 | 1 | 4 | 0 | 2 | 3 | 4 |
| 119 | A2 | 8 | 1 | 2, 6, 9 | 0 | 1 | 3 | 4 |
| 120 | A2 | 8 | 1 | 4 | 0 | 2 | 3 | 4 |
| 121 | A2 | 4 | 0 | 2, 6, 9 | 0 | 1 | 3 | 4 |
| 122 | A2 | 4 | 0 | 4 | 0 | 2 | 3 | 4 |
| 123 | A2 | 2 | 1 | 2, 6, 9 | 0 | 1 | 3 | 4 |
| 124 | A2 | 2 | 0 | 1 | 0 | 2 | 3 | 4 |
| 125 | A2 | 2 | 0 | 4 | 0 | 2 | 3 | 4 |
| 126 | A2 | 2 | 0 | 7 | 0 | 2 | 3 | 4 |
| 127 | A2 | 1 | 0 | 4 | 0 | 1 | 3 | 4 |
| 128 | A2 | 1 | 0 | 1, 6 | 0 | 1 | 3 | 4 |
| 129 | A2 | 1 | 0 | 4, 9 | 0 | 1 | 3 | 4 |
| 130 | A2 | 1 | 0 | 1 | 0 | 2 | 3 | 4 |
| 131 | A2 | 1 | 0 | 7 | 0 | 2 | 3 | 4 |
| 132 | A2 | 1 | 0 | 2, 7 | 0 | 2 | 3 | 4 |
| 133 | A2 | 1 | 0 | 1, 4, 7 | 0 | 2 | 3 | 4 |
| 134 | A2 | 1 | 0 | 0, 2, 4, 6, 8 | 0 | 2 | 3 | 4 |
| 135 | A2 | 1 | 0 | 0, 1, 2, 3, 4, | 0 | 2 | 3 | 4 |
| | | | | 5, 6, 7, 8, 9 | | | | |
| 136 | A2 | 1 | 0 | 1, 3, 5, 7, 9 | 0 | 2 | 3 | 4 |
| 137 | A2/B2 | 2 | 1 | 2, 6, 9 | 0 | 1 | 3 | 4 |
| 138 | A2/B2 | 2 | 0 | 4 | 0 | 2 | 3 | 4 |
| 139 | A2/B2 | 1 | 0 | 4 | 0 | 1 | 3 | 4 |
| 140 | A2/B2 | 1 | 0 | 1, 6 | 0 | 1 | 3 | 4 |
| 141 | A2/B2 | 1 | 0 | 4, 9 | 0 | 1 | 3 | 4 |
| 142 | A2/B2 | 1 | 0 | 1 | 0 | 2 | 3 | 4 |
| 143 | A2/B2 | 1 | 0 | 7 | 0 | 2 | 3 | 4 |
| 144 | A2/B2 | 1 | 0 | 1, 4, 7 | 0 | 2 | 3 | 4 |
| 145 | A2/B2 | 1 | 0 | 0, 2, 4, 6, 8 | 0 | 2 | 3 | 4 |
| 146 | A2/B2 | 1 | 0 | 0, 1, 2, 3, 4, | 0 | 2 | 3 | 4 |
| | | | | 5, 6, 7, 8, 9 | | | | |
| 147 | A3 | 16 | 1 | 4, 9 | 0 | 1 | 2 | 6 |
| 148 | A3 | 16 | 1 | 4 | 0 | 2 | 2 | 6 |
| 149 | A3 | 8 | 1 | 4, 9 | 0 | 1 | 2 | 6 |
| 150 | A3 | 8 | 1 | 4 | 0 | 2 | 2 | 6 |
| 151 | A3 | 4 | 0 | 4, 9 | 0 | 1 | 2 | 6 |
| 152 | A3 | 4 | 0 | 4 | 0 | 2 | 2 | 6 |
| 153 | A3 | 2 | 1 | 2, 6, 9 | 0 | 2 | 2 | 6 |
| 154 | A3 | 2 | 0 | 1 | 0 | 2 | 2 | 6 |
| 155 | A3 | 2 | 0 | 4 | 0 | 2 | 2 | 6 |
| 156 | A3 | 2 | 0 | 7 | 0 | 2 | 2 | 6 |
| 157 | A3 | 1 | 0 | 4 | 0 | 1 | 2 | 6 |
| 158 | A3 | 1 | 0 | 1, 6 | 0 | 1 | 2 | 6 |
| 159 | A3 | 1 | 0 | 4, 9 | 0 | 1 | 2 | 6 |
| 160 | A3 | 1 | 0 | 1 | 0 | 2 | 2 | 6 |
| 161 | A3 | 1 | 0 | 7 | 0 | 2 | 2 | 6 |
| 162 | A3 | 1 | 0 | 2, 7 | 0 | 2 | 2 | 6 |
| 163 | A3 | 1 | 0 | 1, 4, 7 | 0 | 2 | 2 | 6 |
| 164 | A3 | 1 | 0 | 0, 2, 4, 6, 8 | 0 | 2 | 2 | 6 |
| 165 | A3 | 1 | 0 | 0, 1, 2, 3, 4, | 0 | 2 | 2 | 6 |
| | | | | 5, 6, 7, 8, 9 | | | | |
| 166 | A3 | 1 | 0 | 1, 3, 5, 7, 9 | 0 | 2 | 2 | 6 |
| 167 | A3/B3 | 2 | 1 | 2, 6, 9 | 0 | 2 | 2 | 6 |
| 168 | A3/B3 | 2 | 0 | 4 | 0 | 2 | 2 | 6 |
| 169 | A3/B3 | 1 | 0 | 4 | 0 | 1 | 2 | 6 |
| 170 | A3/B3 | 1 | 0 | 1, 6 | 0 | 1 | 2 | 6 |
| 171 | A3/B3 | 1 | 0 | 4, 9 | 0 | 1 | 2 | 6 |
| 172 | A3/B3 | 1 | 0 | 1 | 0 | 2 | 2 | 6 |
| 173 | A3/B3 | 1 | 0 | 7 | 0 | 2 | 2 | 6 |
| 174 | A3/B3 | 1 | 0 | 1, 4, 7 | 0 | 2 | 2 | 6 |
| 175 | A3/B3 | 1 | 0 | 0, 2, 4, 6, 8 | 0 | 2 | 2 | 6 |
| 176 | A3/B3 | 1 | 0 | 0, 1, 2, 3, 4, | 0 | 2 | 2 | 6 |
| | | | | 5, 6, 7, 8, 9 | | | | |
| 177 | B1 | 16 | 0 | 4, 9 | 0 | 1 | 7 | 2 |
| 178 | B1 | 16 | 1 | 4 | 0 | 2 | 7 | 2 |
| 179 | B1 | 8 | 0 | 4, 9 | 0 | 1 | 7 | 2 |
| 180 | B1 | 8 | 1 | 4 | 0 | 2 | 7 | 2 |
| 181 | B1 | 4 | 0 | 4, 9 | 0 | 1 | 7 | 2 |
| 182 | B1 | 4 | 1 | 4, 9 | 0 | 1 | 7 | 2 |
| 183 | B1 | 4 | 0 | 4 | 0 | 2 | 7 | 2 |
| 184 | B1 | 2 | 0 | 4, 9 | 0 | 1 | 7 | 2 |
| 185 | B1 | 2 | 0 | 1 | 0 | 2 | 7 | 2 |
| 186 | B1 | 2 | 0 | 4 | 0 | 2 | 7 | 2 |
| 187 | B1 | 2 | 0 | 7 | 0 | 2 | 7 | 2 |
| 188 | B1 | 1 | 0 | 4 | 0 | 1 | 7 | 2 |
| 189 | B1 | 1 | 0 | 1, 6 | 0 | 1 | 7 | 2 |
| 190 | B1 | 1 | 0 | 4, 9 | 0 | 1 | 7 | 2 |
| 191 | B1 | 1 | 0 | 1 | 0 | 2 | 7 | 2 |
| 192 | B1 | 1 | 0 | 7 | 0 | 2 | 7 | 2 |
| 193 | B1 | 1 | 0 | 2, 7 | 0 | 2 | 7 | 2 |
| 194 | B1 | 1 | 0 | 1, 4, 7 | 0 | 2 | 7 | 2 |
| 195 | B1 | 1 | 0 | 0, 2, 4, 6, 8 | 0 | 2 | 7 | 2 |
| 196 | B1 | 1 | 0 | 0, 1, 2, 3, 4, | 0 | 2 | 7 | 2 |
| | | | | 5, 6, 7, 8, 9 | | | | |
| 197 | B1 | 1 | 0 | 1, 3, 5, 7, 9 | 0 | 2 | 7 | 2 |
| 198 | B4 | 16 | 0 | 4, 9 | 0 | 2 | 1 | 12 |
| 199 | B4 | 16 | 1 | 4 | 0 | 2 | 1 | 12 |
| 200 | B4 | 8 | 0 | 4, 9 | 0 | 2 | 1 | 12 |
| 201 | B4 | 8 | 1 | 4 | 0 | 2 | 1 | 12 |
| 202 | B4 | 4 | 0 | 4, 9 | 0 | 2 | 1 | 12 |
| 203 | B4 | 4 | 0 | 4 | 0 | 2 | 1 | 12 |
| 204 | B4 | 4 | 1 | 4, 9 | 0 | 2 | 1 | 12 |
| 205 | B4 | 2 | 0 | 4, 9 | 0 | 2 | 1 | 12 |
| 206 | B4 | 2 | 0 | 1 | 0 | 2 | 1 | 12 |
| 207 | B4 | 2 | 0 | 4 | 0 | 2 | 1 | 12 |
| 208 | B4 | 2 | 0 | 7 | 0 | 2 | 1 | 12 |
| 209 | B4 | 1 | 0 | 1 | 0 | 2 | 1 | 12 |
| 210 | B4 | 1 | 0 | 4 | 0 | 2 | 1 | 12 |
| 211 | B4 | 1 | 0 | 7 | 0 | 2 | 1 | 12 |
| 212 | B4 | 1 | 0 | 1, 6 | 0 | 2 | 1 | 12 |
| 213 | B4 | 1 | 0 | 2, 7 | 0 | 2 | 1 | 12 |
| 214 | B4 | 1 | 0 | 4, 9 | 0 | 2 | 1 | 12 |
| 215 | B4 | 1 | 0 | 1, 4, 7 | 0 | 2 | 1 | 12 |
| 216 | B4 | 1 | 0 | 0, 2, 4, 6, 8 | 0 | 2 | 1 | 12 |
| 217 | B4 | 1 | 0 | 0, 1, 2, 3, 4, | 0 | 2 | 1 | 12 |
| | | | | 5, 6, 7, 8, 9 | | | | |
| 218 | B4 | 1 | 0 | 1, 3, 5, 7, 9 | 0 | 2 | 1 | 12 |
| 219 | C0 | 8 | 1 | 4 | 0 | 2 | 7 | 2 |
| 220 | C0 | 4 | 1 | 4, 9 | 0 | 1 | 7 | 2 |
| 221 | C0 | 4 | 0 | 4 | 0 | 2 | 7 | 2 |
| 222 | C0 | 2 | 0 | 4, 9 | 0 | 1 | 7 | 2 |
| 223 | C0 | 2 | 0 | 1 | 0 | 2 | 7 | 2 |
| 224 | C0 | 2 | 0 | 4 | 0 | 2 | 7 | 2 |
| 225 | C0 | 2 | 0 | 7 | 0 | 2 | 7 | 2 |
| 226 | C0 | 1 | 0 | 4 | 0 | 1 | 7 | 2 |
| 227 | C0 | 1 | 0 | 1, 6 | 0 | 1 | 7 | 2 |
| 228 | C0 | 1 | 0 | 4, 9 | 0 | 1 | 7 | 2 |
| 229 | C0 | 1 | 0 | 1 | 0 | 2 | 7 | 2 |
| 230 | C0 | 1 | 0 | 7 | 0 | 2 | 7 | 2 |
| 231 | C0 | 1 | 0 | 2, 7 | 0 | 2 | 7 | 2 |
| 232 | C0 | 1 | 0 | 1, 4, 7 | 0 | 2 | 7 | 2 |
| 233 | C0 | 1 | 0 | 0, 2, 4, 6, 8 | 0 | 2 | 7 | 2 |
| 234 | C0 | 1 | 0 | 0, 1, 2, 3, 4, | 0 | 2 | 7 | 2 |
| | | | | 5, 6, 7, 8, 9 | | | | |
| 235 | C0 | 1 | 0 | 1, 3, 5, 7, 9 | 0 | 2 | 7 | 2 |
| 236 | C2 | 16 | 1 | 4, 9 | 0 | 1 | 2 | 6 |
| 237 | C2 | 16 | 1 | 4 | 0 | 2 | 2 | 6 |
| 238 | C2 | 8 | 1 | 4, 9 | 0 | 1 | 2 | 6 |
| 239 | C2 | 8 | 1 | 4 | 0 | 2 | 2 | 6 |
| 240 | C2 | 4 | 0 | 4, 9 | 0 | 1 | 2 | 6 |
| 241 | C2 | 4 | 0 | 4 | 0 | 2 | 2 | 6 |
| 242 | C2 | 2 | 1 | 2, 6, 9 | 0 | 2 | 2 | 6 |
| 243 | C2 | 2 | 0 | 1 | 0 | 2 | 2 | 6 |
| 244 | C2 | 2 | 0 | 4 | 0 | 2 | 2 | 6 |
| 245 | C2 | 2 | 0 | 7 | 0 | 2 | 2 | 6 |
| 246 | C2 | 1 | 0 | 4 | 0 | 1 | 2 | 6 |
| 247 | C2 | 1 | 0 | 1, 6 | 0 | 1 | 2 | 6 |
| 248 | C2 | 1 | 0 | 4, 9 | 0 | 1 | 2 | 6 |
| 249 | C2 | 1 | 0 | 1 | 0 | 2 | 2 | 6 |
| 250 | C2 | 1 | 0 | 7 | 0 | 2 | 2 | 6 |
| 251 | C2 | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, | 0 | 2 | 2 | 6 |
| | | | | 7, 9 | | | | |

TABLE 3
Table 6.3.3.2-3: Random access configurations for FR1 and unpaired spectrum.

| | | | | | | | N_{RA,slot} | |
|---|---|---|---|---|---|---|---|---|
| | | | | | | | number | |
| | | | | | | | of | |
| | | | | | | | time- | |
| | | | | | | Number | domain | |
| | | | | | | of | PRACH | |
| PRACH Configu- | | | | | | PRACH slots | ccasions within a | ${N}_{dur}^{RA} ,$ |
| ration | Preamble | NSFN modx = y | | Subframe | Starting | within a | PRACH | PRACH |
| index | format | x | y | number | symbol | subframe | slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | — | — | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |
| 28 | 1 | 16 | 1 | 7 | 0 | — | — | 0 |
| 29 | 1 | 8 | 1 | 7 | 0 | — | — | 0 |
| 30 | 1 | 4 | 1 | 7 | 0 | — | — | 0 |
| 31 | 1 | 2 | 0 | 7 | 0 | — | — | 0 |
| 32 | 1 | 2 | 1 | 7 | 0 | — | — | 0 |
| 33 | 1 | 1 | 0 | 7 | 0 | — | — | 0 |
| 34 | 2 | 16 | 1 | 6 | 0 | — | — | 0 |
| 35 | 2 | 8 | 1 | 6 | 0 | — | — | 0 |
| 36 | 2 | 4 | 1 | 6 | 0 | — | — | 0 |
| 37 | 2 | 2 | 0 | 6 | 7 | — | — | 0 |
| 38 | 2 | 2 | 1 | 6 | 7 | — | — | 0 |
| 39 | 2 | 1 | 0 | 6 | 7 | — | — | 0 |
| 40 | 3 | 16 | 1 | 9 | 0 | — | — | 0 |
| 41 | 3 | 8 | 1 | 9 | 0 | — | — | 0 |
| 42 | 3 | 4 | 1 | 9 | 0 | — | — | 0 |
| 43 | 3 | 2 | 0 | 9 | 0 | — | — | 0 |
| 44 | 3 | 2 | 1 | 9 | 0 | — | — | 0 |
| 45 | 3 | 2 | 0 | 4 | 0 | — | — | 0 |
| 46 | 3 | 2 | 1 | 4 | 0 | — | — | 0 |
| 47 | 3 | 1 | 0 | 9 | 0 | — | — | 0 |
| 48 | 3 | 1 | 0 | 8 | 0 | — | — | 0 |
| 49 | 3 | 1 | 0 | 7 | 0 | — | — | 0 |
| 50 | 3 | 1 | 0 | 6 | 0 | — | — | 0 |
| 51 | 3 | 1 | 0 | 5 | 0 | — | — | 0 |
| 52 | 3 | 1 | 0 | 4 | 0 | — | — | 0 |
| 53 | 3 | 1 | 0 | 3 | 0 | — | — | 0 |
| 54 | 3 | 1 | 0 | 2 | 0 | — | — | 0 |
| 55 | 3 | 1 | 0 | 1, 6 | 0 | — | — | 0 |
| 56 | 3 | 1 | 0 | 1, 6 | 7 | — | — | 0 |
| 57 | 3 | 1 | 0 | 4, 9 | 0 | — | — | 0 |
| 58 | 3 | 1 | 0 | 3, 8 | 0 | — | — | 0 |
| 59 | 3 | 1 | 0 | 2, 7 | 0 | — | — | 0 |
| 60 | 3 | 1 | 0 | 8, 9 | 0 | — | — | 0 |
| 61 | 3 | 1 | 0 | 4, 8, 9 | 0 | — | — | 0 |
| 62 | 3 | 1 | 0 | 3, 4, 9 | 0 | — | — | 0 |
| 63 | 3 | 1 | 0 | 7, 8, 9 | 0 | — | — | 0 |
| 64 | 3 | 1 | 0 | 3, 4, 8, 9 | 0 | — | — | 0 |
| 65 | 3 | 1 | 0 | 1, 4, 6, 9 | 0 | — | — | 0 |
| 66 | 3 | 1 | 0 | 1, 3, 5, 7, 9 | 0 | — | — | 0 |
| 67 | A1 | 16 | 1 | 9 | 0 | 2 | 6 | 2 |
| 68 | A1 | 8 | 1 | 9 | 0 | 2 | 6 | 2 |
| 69 | A1 | 4 | 1 | 9 | 0 | 1 | 6 | 2 |
| 70 | A1 | 2 | 1 | 9 | 0 | 1 | 6 | 2 |
| 71 | A1 | 2 | 1 | 4, 9 | 7 | 1 | 3 | 2 |
| 72 | A1 | 2 | 1 | 7, 9 | 7 | 1 | 3 | 2 |
| 73 | A1 | 2 | 1 | 7, 9 | 0 | 1 | 6 | 2 |
| 74 | A1 | 2 | 1 | 8, 9 | 0 | 2 | 6 | 2 |
| 75 | A1 | 2 | 1 | 4, 9 | 0 | 2 | 6 | 2 |
| 76 | A1 | 2 | 1 | 2, 3, 4, 7, 8, 9 | 0 | 1 | 6 | 2 |
| 77 | A1 | 1 | 0 | 9 | 0 | 2 | 6 | 2 |
| 78 | A1 | 1 | 0 | 9 | 7 | 1 | 3 | 2 |
| 79 | A1 | 1 | 0 | 9 | 0 | 1 | 6 | 2 |
| 80 | A1 | 1 | 0 | 8, 9 | 0 | 2 | 6 | 2 |
| 81 | A1 | 1 | 0 | 4, 9 | 0 | 1 | 6 | 2 |
| 82 | A1 | 1 | 0 | 7, 9 | 7 | 1 | 3 | 2 |
| 83 | A1 | 1 | 0 | 3, 4, 8, 9 | 0 | 1 | 6 | 2 |
| 84 | A1 | 1 | 0 | 3, 4, 8, 9 | 0 | 2 | 6 | 2 |
| 85 | A1 | 1 | 0 | 1, 3, 5, 7, 9 | 0 | 1 | 6 | 2 |
| 86 | A1 | 1 | 0 | 0, 1, 2, 3, 4, | 7 | 1 | 3 | 2 |
| | | | | 5, 6, 7, 8, 9 | | | | |
| 87 | A2 | 16 | 1 | 9 | 0 | 2 | 3 | 4 |
| 88 | A2 | 8 | 1 | 9 | 0 | 2 | 3 | 4 |
| 89 | A2 | 4 | 1 | 9 | 0 | 1 | 3 | 4 |
| 90 | A2 | 2 | 1 | 7, 9 | 0 | 1 | 3 | 4 |
| 91 | A2 | 2 | 1 | 8, 9 | 0 | 2 | 3 | 4 |
| 92 | A2 | 2 | 1 | 7, 9 | 9 | 1 | 1 | 4 |
| 93 | A2 | 2 | 1 | 4, 9 | 9 | 1 | 1 | 4 |
| 94 | A2 | 2 | 1 | 4, 9 | 0 | 2 | 3 | 4 |
| 95 | A2 | 2 | 1 | 2, 3, 4, 7, | 0 | 1 | 3 | 4 |
| | | | | 8, 9 | | | | |
| 96 | A2 | 1 | 0 | 2 | 0 | 1 | 3 | 4 |
| 97 | A2 | 1 | 0 | 7 | 0 | 1 | 3 | 4 |
| 98 | A2 | 2 | 1 | 9 | 0 | 1 | 3 | 4 |
| 99 | A2 | 1 | 0 | 9 | 0 | 2 | 3 | 4 |
| 100 | A2 | 1 | 0 | 9 | 9 | 1 | 1 | 4 |
| 101 | A2 | 1 | 0 | 9 | 0 | 1 | 3 | 4 |
| 102 | A2 | 1 | 0 | 2, 7 | 0 | 1 | 3 | 4 |
| 103 | A2 | 1 | 0 | 8, 9 | 0 | 2 | 3 | 4 |
| 104 | A2 | 1 | 0 | 4, 9 | 0 | 1 | 3 | 4 |
| 105 | A2 | 1 | 0 | 7, 9 | 9 | 1 | 1 | 4 |
| 106 | A2 | 1 | 0 | 3, 4, 8, 9 | 0 | 1 | 3 | 4 |
| 107 | A2 | 1 | 0 | 3, 4, 8, 9 | 0 | 2 | 3 | 4 |
| 108 | A2 | 1 | 0 | 1, 3, 5, 7, 9 | 0 | 1 | 3 | 4 |
| 109 | A2 | 1 | 0 | 0, 1, 2, 3, | 9 | 1 | 1 | 4 |
| | | | | 4, 5, 6, 7, | | | | |
| | | | | 8, 9 | | | | |
| 110 | A3 | 16 | 1 | 9 | 0 | 2 | 2 | 6 |
| 111 | A3 | 8 | 1 | 9 | 0 | 2 | 2 | 6 |
| 112 | A3 | 4 | 1 | 9 | 0 | 1 | 2 | 6 |
| 113 | A3 | 2 | 1 | 4, 9 | 7 | 1 | 1 | 6 |
| 114 | A3 | 2 | 1 | 7, 9 | 7 | 1 | 1 | 6 |
| 115 | A3 | 2 | 1 | 7, 9 | 0 | 1 | 2 | 6 |
| 116 | A3 | 2 | 1 | 4, 9 | 0 | 2 | 2 | 6 |
| 117 | A3 | 2 | 1 | 8, 9 | 0 | 2 | 2 | 6 |
| 118 | A3 | 2 | 1 | 2, 3, 4, 7, | 0 | 1 | 2 | 6 |
| | | | | 8, 9 | | | | |
| 119 | A3 | 1 | 0 | 2 | 0 | 1 | 2 | 6 |
| 120 | A3 | 1 | 0 | 7 | 0 | 1 | 2 | 6 |
| 121 | A3 | 2 | 1 | 9 | 0 | 1 | 2 | 6 |
| 122 | A3 | 1 | 0 | 9 | 0 | 2 | 2 | 6 |
| 123 | A3 | 1 | 0 | 9 | 7 | 1 | 1 | 6 |
| 124 | A3 | 1 | 0 | 9 | 0 | 1 | 2 | 6 |
| 125 | A3 | 1 | 0 | 2, 7 | 0 | 1 | 2 | 6 |
| 126 | A3 | 1 | 0 | 8, 9 | 0 | 2 | 2 | 6 |
| 127 | A3 | 1 | 0 | 4, 9 | 0 | 1 | 2 | 6 |
| 128 | A3 | 1 | 0 | 7, 9 | 7 | 1 | 1 | 6 |
| 129 | A3 | 1 | 0 | 3, 4, 8, 9 | 0 | 1 | 2 | 6 |
| 130 | A3 | 1 | 0 | 3, 4, 8, 9 | 0 | 2 | 2 | 6 |
| 131 | A3 | 1 | 0 | 1, 3, 5, 7, 9 | 0 | 1 | 2 | 6 |
| 132 | A3 | 1 | 0 | 0, 1, 2, 3, 4, | 7 | 1 | 1 | 6 |
| | | | | 5, 6, 7, 8, 9 | | | | |
| 133 | B1 | 4 | 1 | 9 | 2 | 1 | 6 | 2 |
| 134 | B1 | 2 | 1 | 9 | 2 | 1 | 6 | 2 |
| 135 | B1 | 2 | 1 | 7, 9 | 2 | 1 | 6 | 2 |
| 136 | B1 | 2 | 1 | 4, 9 | 8 | 1 | 3 | 2 |
| 137 | B1 | 2 | 1 | 4, 9 | 2 | 2 | 6 | 2 |
| 138 | B1 | 1 | 0 | 9 | 2 | 2 | 6 | 2 |
| 139 | B1 | 1 | 0 | 9 | 8 | 1 | 3 | 2 |
| 140 | B1 | 1 | 0 | 9 | 2 | 1 | 6 | 2 |
| 141 | B1 | 1 | 0 | 8, 9 | 2 | 2 | 6 | 2 |
| 142 | B1 | 1 | 0 | 4, 9 | 2 | 1 | 6 | 2 |
| 143 | B1 | 1 | 0 | 7, 9 | 8 | 1 | 3 | 2 |
| 144 | B1 | 1 | 0 | 1, 3, 5, 7, 9 | 2 | 1 | 6 | 2 |
| 145 | B4 | 16 | 1 | 9 | 0 | 2 | 1 | 12 |
| 146 | B4 | 8 | 1 | 9 | 0 | 2 | 1 | 12 |
| 147 | B4 | 4 | 1 | 9 | 2 | 1 | 1 | 12 |
| 148 | B4 | 2 | 1 | 9 | 0 | 1 | 1 | 12 |
| 149 | B4 | 2 | 1 | 9 | 2 | 1 | 1 | 12 |
| 150 | B4 | 2 | 1 | 7, 9 | 2 | 1 | 1 | 12 |
| 151 | B4 | 2 | 1 | 4, 9 | 2 | 1 | 1 | 12 |
| 152 | B4 | 2 | 1 | 4, 9 | 0 | 2 | 1 | 12 |
| 153 | B4 | 2 | 1 | 8, 9 | 0 | 2 | 1 | 12 |
| 154 | B4 | 2 | 1 | 2, 3, 4, 7, 8, 9 | 0 | 1 | 1 | 12 |
| 155 | B4 | 1 | 0 | 1 | 0 | 1 | 1 | 12 |
| 156 | B4 | 1 | 0 | 2 | 0 | 1 | 1 | 12 |
| 157 | B4 | 1 | 0 | 4 | 0 | 1 | 1 | 12 |
| 158 | B4 | 1 | 0 | 7 | 0 | 1 | 1 | 12 |
| 159 | B4 | 1 | 0 | 9 | 0 | 1 | 1 | 12 |
| 160 | B4 | 1 | 0 | 9 | 2 | 1 | 1 | 12 |
| 161 | B4 | 1 | 0 | 9 | 0 | 2 | 1 | 12 |
| 162 | B4 | 1 | 0 | 4, 9 | 2 | 1 | 1 | 12 |
| 163 | B4 | 1 | 0 | 7, 9 | 2 | 1 | 1 | 12 |
| 164 | B4 | 1 | 0 | 8, 9 | 0 | 2 | 1 | 12 |
| 165 | B4 | 1 | 0 | 3, 4, 8, 9 | 2 | 1 | 1 | 12 |
| 166 | B4 | 1 | 0 | 1, 3, 5, 7, 9 | 2 | 1 | 1 | 12 |
| 167 | B4 | 1 | 0 | 0, 1, 2, 3, 4, 5, 6, 7, 8, 9 | 0 | 2 | 1 | 12 |
| 168 | B4 | 1 | 0 | 0, 1, 2, 3, 4, 5, 6, 7, 8, 9 | 2 | 1 | 1 | 12 |
| 169 | C0 | 16 | 1 | 9 | 2 | 2 | 6 | 2 |
| 170 | C0 | 8 | 1 | 9 | 2 | 2 | 6 | 2 |
| 171 | C0 | 4 | 1 | 9 | 2 | 1 | 6 | 2 |
| 172 | C0 | 2 | 1 | 9 | 2 | 1 | 6 | 2 |
| 173 | C0 | 2 | 1 | 8, 9 | 2 | 2 | 6 | 2 |
| 174 | C0 | 2 | 1 | 7, 9 | 2 | 1 | 6 | 2 |
| 175 | C0 | 2 | 1 | 7, 9 | 8 | 1 | 3 | 2 |
| 176 | C0 | 2 | 1 | 4, 9 | 8 | 1 | 3 | 2 |
| 177 | C0 | 2 | 1 | 4, 9 | 2 | 2 | 6 | 2 |
| 178 | C0 | 2 | 1 | 2, 3, 4, 7, | 2 | 1 | 6 | 2 |
| | | | | 8, 9 | | | | |
| 179 | C0 | 1 | 0 | 9 | 2 | 2 | 6 | 2 |
| 180 | C0 | 1 | 0 | 9 | 8 | 1 | 3 | 2 |
| 181 | C0 | 1 | 0 | 9 | 2 | 1 | 6 | 2 |
| 182 | C0 | 1 | 0 | 8, 9 | 2 | 2 | 6 | 2 |
| 183 | C0 | 1 | 0 | 4, 9 | 2 | 1 | 6 | 2 |
| 184 | C0 | 1 | 0 | 7, 9 | 8 | 1 | 3 | 2 |
| 185 | C0 | 1 | 0 | 3, 4, 8, 9 | 2 | 1 | 6 | 2 |
| 186 | C0 | 1 | 0 | 3, 4, 8, 9 | 2 | 2 | 6 | 2 |
| 187 | C0 | 1 | 0 | 1, 3, 5, 7, 9 | 2 | 1 | 6 | 2 |
| 188 | C0 | 1 | 0 | 0, 1, 2, 3, 4, 5, 6, 7, 8, 9 | 8 | 1 | 3 | 2 |
| 189 | C2 | 16 | 1 | 9 | 2 | 2 | 2 | 6 |
| 190 | C2 | 8 | 1 | 9 | 2 | 2 | 2 | 6 |
| 191 | C2 | 4 | 1 | 9 | 2 | 1 | 2 | 6 |
| 192 | C2 | 2 | 1 | 9 | 2 | 1 | 2 | 6 |
| 193 | C2 | 2 | 1 | 8, 9 | 2 | 2 | 2 | 6 |
| 194 | C2 | 2 | 1 | 7, 9 | 2 | 1 | 2 | 6 |
| 195 | C2 | 2 | 1 | 7, 9 | 8 | 1 | 1 | 6 |
| 196 | C2 | 2 | 1 | 4, 9 | 8 | 1 | 1 | 6 |
| 197 | C2 | 2 | 1 | 4, 9 | 2 | 2 | 2 | 6 |
| 198 | C2 | 2 | 1 | 2, 3, 4, 7, | 2 | 1 | 2 | 6 |
| | | | | 8, 9 | | | | |
| 199 | C2 | 8 | 1 | 9 | 8 | 2 | 1 | 6 |
| 200 | C2 | 4 | 1 | 9 | 8 | 1 | 1 | 6 |
| 201 | C2 | 1 | 0 | 9 | 2 | 2 | 2 | 6 |
| 202 | C2 | 1 | 0 | 9 | 8 | 1 | 1 | 6 |
| 203 | C2 | 1 | 0 | 9 | 2 | 1 | 2 | 6 |
| 204 | C2 | 1 | 0 | 8, 9 | 2 | 2 | 2 | 6 |
| 205 | C2 | 1 | 0 | 4, 9 | 2 | 1 | 2 | 6 |
| 206 | C2 | 1 | 0 | 7, 9 | 8 | 1 | 1 | 6 |
| 207 | C2 | 1 | 0 | 3, 4, 8, 9 | 2 | 1 | 2 | 6 |
| 208 | C2 | 1 | 0 | 3, 4, 8, 9 | 2 | 2 | 2 | 6 |
| 209 | C2 | 1 | 0 | 1, 3, 5, 7, 9 | 2 | 1 | 2 | 6 |
| 210 | C2 | 1 | 0 | 0, 1, 2, 3, 4, | 8 | 1 | 1 | 6 |
| | | | | 5, 6, 7, 8, 9 | | | | |
| 211 | A1/B1 | 2 | 1 | 9 | 2 | 1 | 6 | 2 |
| 212 | A1/B1 | 2 | 1 | 4, 9 | 8 | 1 | 3 | 2 |
| 213 | A1/B1 | 2 | 1 | 7, 9 | 8 | 1 | 3 | 2 |
| 214 | A1/B1 | 2 | 1 | 7, 9 | 2 | 1 | 6 | 2 |
| 215 | A1/B1 | 2 | 1 | 4, 9 | 2 | 2 | 6 | 2 |
| 216 | A1/B1 | 2 | 1 | 8, 9 | 2 | 2 | 6 | 2 |
| 217 | A1/B1 | 1 | 0 | 9 | 2 | 2 | 6 | 2 |
| 218 | A1/B1 | 1 | 0 | 9 | 8 | 1 | 3 | 2 |
| 219 | A1/B1 | 1 | 0 | 9 | 2 | 1 | 6 | 2 |
| 220 | A1/B1 | 1 | 0 | 8, 9 | 2 | 2 | 6 | 2 |
| 221 | A1/B1 | 1 | 0 | 4, 9 | 2 | 1 | 6 | 2 |
| 222 | A1/B1 | 1 | 0 | 7, 9 | 8 | 1 | 3 | 2 |
| 223 | A1/B1 | 1 | 0 | 3, 4, 8, 9 | 2 | 2 | 6 | 2 |
| 224 | A1/B1 | 1 | 0 | 1, 3, 5, 7, 9 | 2 | 1 | 6 | 2 |
| 225 | A1/B1 | 1 | 0 | 0, 1, 2, 3, 4, | 8 | 1 | 3 | 2 |
| | | | | 5, 6, 7, 8, 9 | | | | |
| 226 | A2/B2 | 2 | 1 | 9 | 0 | 1 | 3 | 4 |
| 227 | A2/B2 | 2 | 1 | 4, 9 | 6 | 1 | 2 | 4 |
| 228 | A2/B2 | 2 | 1 | 7, 9 | 6 | 1 | 2 | 4 |
| 229 | A2/B2 | 2 | 1 | 4, 9 | 0 | 2 | 3 | 4 |
| 230 | A2/B2 | 2 | 1 | 8, 9 | 0 | 2 | 3 | 4 |
| 231 | A2/B2 | 1 | 0 | 9 | 0 | 2 | 3 | 4 |
| 232 | A2/B2 | 1 | 0 | 9 | 6 | 1 | 2 | 4 |
| 233 | A2/B2 | 1 | 0 | 9 | 0 | 1 | 3 | 4 |
| 234 | A2/B2 | 1 | 0 | 8, 9 | 0 | 2 | 3 | 4 |
| 235 | A2/B2 | 1 | 0 | 4, 9 | 0 | 1 | 3 | 4 |
| 236 | A2/B2 | 1 | 0 | 7, 9 | 6 | 1 | 2 | 4 |
| 237 | A2/B2 | 1 | 0 | 3, 4, 8, 9 | 0 | 1 | 3 | 4 |
| 238 | A2/B2 | 1 | 0 | 3, 4, 8, 9 | 0 | 2 | 3 | 4 |
| 239 | A2/B2 | 1 | 0 | 1, 3, 5, 7, 9 | 0 | 1 | 3 | 4 |
| 240 | A2/B2 | 1 | 0 | 0, 1, 2, 3, 4, 5, 6, 7, 8, 9 | 6 | 1 | 2 | 4 |
| 241 | A3/B3 | 2 | 1 | 9 | 0 | 1 | 2 | 6 |
| 242 | A3/B3 | 2 | 1 | 4, 9 | 2 | 1 | 2 | 6 |
| 243 | A3/B3 | 2 | 1 | 7, 9 | 0 | 1 | 2 | 6 |
| 244 | A3/B3 | 2 | 1 | 7, 9 | 2 | 1 | 2 | 6 |
| 245 | A3/B3 | 2 | 1 | 4, 9 | 0 | 2 | 2 | 6 |
| 246 | A3/B3 | 2 | 1 | 8, 9 | 0 | 2 | 2 | 6 |
| 247 | A3/B3 | 1 | 0 | 9 | 0 | 2 | 2 | 6 |
| 248 | A3/B3 | 1 | 0 | 9 | 2 | 1 | 2 | 6 |
| 249 | A3/B3 | 1 | 0 | 9 | 0 | 1 | 2 | 6 |
| 250 | A3/B3 | 1 | 0 | 8, 9 | 0 | 2 | 2 | 6 |
| 251 | A3/B3 | 1 | 0 | 4, 9 | 0 | 1 | 2 | 6 |
| 252 | A3/B3 | 1 | 0 | 7, 9 | 2 | 1 | 2 | 6 |
| 253 | A3/B3 | 1 | 0 | 3, 4, 8, 9 | 0 | 2 | 2 | 6 |
| 254 | A3/B3 | 1 | 0 | 1, 3, 5, 7, 9 | 0 | 1 | 2 | 6 |
| 255 | A3/B3 | 1 | 0 | 0, 1, 2, 3, 4, 5, 6, 7, 8, 9 | 2 | 1 | 2 | 6 |
| 256 | 0 | 16 | 1 | 7 | 0 | — | — | 0 |
| 257 | 0 | 8 | 1 | 7 | 0 | — | — | 0 |
| 258 | 0 | 4 | 1 | 7 | 0 | — | — | 0 |
| 259 | 0 | 2 | 0 | 7 | 0 | — | — | 0 |
| 260 | 0 | 2 | 1 | 7 | 0 | — | — | 0 |
| 261 | 0 | 2 | 0 | 2 | 0 | — | — | 0 |
| 262 | 0 | 2 | 1 | 2 | 0 | — | — | 0 |

TABLE 4
Table 6.3.3.2-4: Random access configurations for FR2 and unpaired spectrum.

| | | | | | | | N^{RA,slot}, | |
|---|---|---|---|---|---|---|---|---|
| | | | | | | | number | |
| | | | | | | | of | |
| | | | | | | | time- | |
| | | | | | | | domain | |
| | | | | | | Number | PRACH | |
| | | | | | | of | ccasions | |
| PRACH Configu- | | | | | | PRACH slots | within a | ${N}_{dur}^{R A} ,$ |
| ration | Preamble | N_{SFN} modx = y | | Subframe | Starting | within a | PRACH | PRACH |
| index | format | x | y | number | symbol | subframe | slot | duration |
| 0 | A1 | 16 | 1 | 4, 9, 14, 19, | 0 | 2 | 6 | 2 |
| | | | | 24, 29, 34, 39 | | | | |
| 1 | A1 | 16 | 1 | 3, 7, 11, 15, | 0 | 1 | 6 | 2 |
| | | | | 19, 23, 27, | | | | |
| | | | | 31, 35, 39 | | | | |
| 2 | A1 | 8 | 1, 2 | 9, 19, 29, 39 | 0 | 2 | 6 | 2 |
| 3 | A1 | 8 | 1 | 4, 9, 14, 19, | 0 | 2 | 6 | 2 |
| | | | | 24, 29, 34, 39 | | | | |
| 4 | A1 | 8 | 1 | 3, 7, 11, 15, | 0 | 1 | 6 | 2 |
| | | | | 19, 23, 27, 31, | | | | |
| | | | | 35, 39 | | | | |
| 5 | A1 | 4 | 1 | 4, 9, 14, 19, | 0 | 1 | 6 | 2 |
| | | | | 24, 29, 34, 39 | | | | |
| 6 | A1 | 4 | 1 | 4, 9, 14, 19, | 0 | 2 | 6 | 2 |
| | | | | 24, 29, 34, 39 | | | | |
| 7 | A1 | 4 | 1 | 3, 7, 11, 15, | 0 | 1 | 6 | 2 |
| | | | | 19, 23, 27, 31, | | | | |
| | | | | 35, 39 | | | | |
| 8 | A1 | 2 | 1 | 7, 15, 23, 31, 39 | 0 | 2 | 6 | 2 |
| 9 | A1 | 2 | 1 | 4, 9, 14, 19, | 0 | 1 | 6 | 2 |
| | | | | 24, 29, 34, 39 | | | | |
| 10 | A1 | 2 | 1 | 4, 9, 14, 19, | 0 | 2 | 6 | 2 |
| | | | | 24, 29, 34, 39 | | | | |
| 11 | A1 | 2 | 1 | 3, 7, 11, 15, | 0 | 1 | 6 | 2 |
| | | | | 19, 23, 27, 31, | | | | |
| | | | | 35, 39 | | | | |
| 12 | A1 | 1 | 0 | 19, 39 | 7 | 1 | 3 | 2 |
| 13 | A1 | 1 | 0 | 3, 5, 7 | 0 | 1 | 6 | 2 |
| 14 | A1 | 1 | 0 | 24, 29, 34, 39 | 7 | 1 | 3 | 2 |
| 15 | A1 | 1 | 0 | 9, 19, 29, 39 | 7 | 2 | 3 | 2 |
| 16 | A1 | 1 | 0 | 17, 19, 37, 39 | 0 | 1 | 6 | 2 |
| 17 | A1 | 1 | 0 | 9, 19, 29, 39 | 0 | 2 | 6 | 2 |
| 18 | A1 | 1 | 0 | 4, 9, 14, 19, | 0 | 1 | 6 | 2 |
| | | | | 24, 29, 34, 39 | | | | |
| 19 | A1 | 1 | 0 | 4, 9, 14, 19, | 7 | 1 | 3 | 2 |
| | | | | 24, 29, 34, 39 | | | | |
| 20 | A1 | 1 | 0 | 3, 5, 7, 9, | 7 | 1 | 3 | 2 |
| | | | | 11, 13 | | | | |
| 21 | A1 | 1 | 0 | 23, 27, 31, 35, | 7 | 1 | 3 | 2 |
| | | | | 39 | | | | |
| 22 | A1 | 1 | 0 | 7, 15, 23, 31, | 0 | 1 | 6 | 2 |
| | | | | 39 | | | | |
| 23 | A1 | 1 | 0 | 23, 27, 31, 35, | 0 | 1 | 6 | 2 |
| | | | | 39 | | | | |
| 24 | A1 | 1 | 0 | 13, 14, 15, 29, | 7 | 2 | 3 | 2 |
| | | | | 30, 31, 37, 38, | | | | |
| | | | | 39 | | | | |
| 25 | A1 | 1 | 0 | 3, 7, 11, 15, | 7 | 1 | 3 | 2 |
| | | | | 19, 23, 27, 31, | | | | |
| | | | | 35, 39 | | | | |
| 26 | A1 | 1 | 0 | 3, 7, 11, 15, | 0 | 1 | 6 | 2 |
| | | | | 19, 23, 27, 31, | | | | |
| | | | | 35, 39 | | | | |
| 27 | A1 | 1 | 0 | 1, 3, 5, 7, ... , | 0 | 1 | 6 | 2 |
| | | | | 37, 39 | | | | |
| 28 | A1 | 1 | 0 | 0, 1, 2, ... , 39 | 7 | 1 | 3 | 2 |
| 29 | A2 | 16 | 1 | 4, 9, 14, 19, | 0 | 2 | 3 | 4 |
| | | | | 24, 29, 34, 39 | | | | |
| 30 | A2 | 16 | 1 | 3, 7, 11, 15, | 0 | 1 | 3 | 4 |
| | | | | 19, 23, 27, 31, | | | | |
| | | | | 35, 39 | | | | |
| 31 | A2 | 8 | 1 | 4, 9, 14, 19, | 0 | 2 | 3 | 4 |
| | | | | 24, 29, 34, 39 | | | | |
| 32 | A2 | 8 | 1 | 3, 7, 11, 15, | 0 | 1 | 3 | 4 |
| | | | | 19, 23, 27, 31, | | | | |
| | | | | 35, 39 | | | | |
| 33 | A2 | 8 | 1, 2 | 9, 19, 29, 39 | 0 | 2 | 3 | 4 |
| 34 | A2 | 4 | 1 | 4, 9, 14, 19, | 0 | 1 | 3 | 4 |
| | | | | 24, 29, 34, 39 | | | | |
| 35 | A2 | 4 | 1 | 4, 9, 14, 19, | 0 | 2 | 3 | 4 |
| | | | | 24, 29, 34, 39 | | | | |
| 36 | A2 | 4 | 1 | 3, 7, 11, 15, | 0 | 1 | 3 | 4 |
| | | | | 19, 23, 27, 31, | | | | |
| | | | | 35, 39 | | | | |
| 37 | A2 | 2 | 1 | 7, 15, 23, 31, 39 | 0 | 2 | 3 | 4 |
| 38 | A2 | 2 | 1 | 4, 9, 14, 19, | 0 | 1 | 3 | 4 |
| | | | | 24, 29, 34, 39 | | | | |
| 39 | A2 | 2 | 1 | 4, 9, 14, 19, | 0 | 2 | 3 | 4 |
| | | | | 24, 29, 34, 39 | | | | |
| 40 | A2 | 2 | 1 | 3, 7, 11, 15, | 0 | 1 | 3 | 4 |
| | | | | 19, 23, 27, 31, | | | | |
| | | | | 35, 39 | | | | |
| 41 | A2 | 1 | 0 | 19, 39 | 5 | 1 | 2 | 4 |
| 42 | A2 | 1 | 0 | 3, 5, 7 | 0 | 1 | 3 | 4 |
| 43 | A2 | 1 | 0 | 24, 29, 34, 39 | 5 | 1 | 2 | 4 |
| 44 | A2 | 1 | 0 | 9, 19, 29, 39 | 5 | 2 | 2 | 4 |
| 45 | A2 | 1 | 0 | 17, 19, 37, 39 | 0 | 1 | 3 | 4 |
| 46 | A2 | 1 | 0 | 9, 19, 29, 39 | 0 | 2 | 3 | 4 |
| 47 | A2 | 1 | 0 | 7, 15, 23, 31, 39 | 0 | 1 | 3 | 4 |
| 48 | A2 | 1 | 0 | 23, 27, 31, 35, 39 | 5 | 1 | 2 | 4 |
| 49 | A2 | 1 | 0 | 23, 27, 31, 35, 39 | 0 | 1 | 3 | 4 |
| 50 | A2 | 1 | 0 | 3, 5, 7, 9, | 5 | 1 | 2 | 4 |
| | | | | 11, 13 | | | | |
| 51 | A2 | 1 | 0 | 3, 5, 7, 9, | 0 | 1 | 3 | 4 |
| | | | | 11, 13 | | | | |
| 52 | A2 | 1 | 0 | 4, 9, 14, 19, | 5 | 1 | 2 | 4 |
| | | | | 24, 29, 34, 39 | | | | |
| 53 | A2 | 1 | 0 | 4, 9, 14, 19, | 0 | 1 | 3 | 4 |
| | | | | 24, 29, 34, 39 | | | | |
| 54 | A2 | 1 | 0 | 13, 14, 15, 29, | 5 | 2 | 2 | 4 |
| | | | | 30, 31, 37, 38, | | | | |
| | | | | 39 | | | | |
| 55 | A2 | 1 | 0 | 3, 7, 11, 15, | 5 | 1 | 2 | 4 |
| | | | | 19, 23, 27, 31, | | | | |
| | | | | 35, 39 | | | | |
| 56 | A2 | 1 | 0 | 3, 7, 11, 15, | 0 | 1 | 2 | 4 |
| | | | | 19, 23, 27, 31, | | | | |
| | | | | 35, 39 | | | | |
| 57 | A2 | 1 | 0 | 1, 3, 5, 7, ... , | 0 | 1 | 3 | 4 |
| | | | | 37, 39 | | | | |
| 58 | A2 | 1 | 0 | 0, 1, 2, ... , 39 | 5 | 1 | 2 | 4 |
| 59 | A3 | 16 | 1 | 4, 9, 14, 19, | 0 | 2 | 2 | 6 |
| | | | | 24, 29, 34, 39 | | | | |
| 60 | A3 | 16 | 1 | 3, 7, 11, 15, | 0 | 1 | 2 | 6 |
| | | | | 19, 23, 27, 31, | | | | |
| | | | | 35, 39 | | | | |
| 61 | A3 | 8 | 1 | 4, 9, 14, 19, | 0 | 2 | 2 | 6 |
| | | | | 24, 29, 34, 39 | | | | |
| 62 | A3 | 8 | 1 | 3, 7, 11, 15, | 0 | 1 | 2 | 6 |
| | | | | 19, 23, 27, 31, | | | | |
| | | | | 35, 39 | | | | |
| 63 | A3 | 8 | 1, 2 | 9, 19, 29, 39 | 0 | 2 | 2 | 6 |
| 64 | A3 | 4 | 1 | 4, 9, 14, 19, | 0 | 1 | 2 | 6 |
| | | | | 24, 29, 34, 39 | | | | |
| 65 | A3 | 4 | 1 | 4, 9, 14, 19, | 0 | 2 | 2 | 6 |
| | | | | 24, 29, 34, 39 | | | | |
| 66 | A3 | 4 | 1 | 3, 7, 11, 15, 19, | 0 | 1 | 2 | 6 |
| | | | | 23, 27, 31, 35, 39 | | | | |
| 67 | A3 | 2 | 1 | 4, 9, 14, 19, | 0 | 1 | 2 | 6 |
| | | | | 24, 29, 34, 39 | | | | |
| 68 | A3 | 2 | 1 | 4, 9, 14, 19, | 0 | 2 | 2 | 6 |
| | | | | 24, 29, 34, 39 | | | | |
| 69 | A3 | 2 | 1 | 3, 7, 11, 15, 19, | 0 | 1 | 2 | 6 |
| | | | | 23, 27, 31, 35, 39 | | | | |
| 70 | A3 | 1 | 0 | 19, 39 | 7 | 1 | 1 | 6 |
| 71 | A3 | 1 | 0 | 3, 5, 7 | 0 | 1 | 2 | 6 |
| 72 | A3 | 1 | 0 | 9, 11, 13 | 0 | 1 | 2 | 6 |
| 73 | A3 | 1 | 0 | 24, 29, 34, 39 | 7 | 1 | 1 | 6 |
| 74 | A3 | 1 | 0 | 9, 19, 29, 39 | 7 | 2 | 1 | 6 |
| 75 | A3 | 1 | 0 | 17, 19, 37, 39 | 0 | 1 | 2 | 6 |
| 76 | A3 | 1 | 0 | 9, 19, 29, 39 | 0 | 2 | 2 | 6 |
| 77 | A3 | 1 | 0 | 7, 15, 23, 31, 39 | 0 | 1 | 2 | 6 |
| 78 | A3 | 1 | 0 | 23, 27, 31, 35, 39 | 7 | 1 | 1 | 6 |
| 79 | A3 | 1 | 0 | 23, 27, 31, 35, 39 | 0 | 1 | 2 | 6 |
| 80 | A3 | 1 | 0 | 3, 5, 7, 9, 11, 13 | 0 | 1 | 2 | 6 |
| 81 | A3 | 1 | 0 | 3, 5, 7, 9, 11, 13 | 7 | 1 | 1 | 6 |
| 82 | A3 | 1 | 0 | 4, 9, 14, 19, | 0 | 1 | 2 | 6 |
| | | | | 24, 29, 34, 39 | | | | |
| 83 | A3 | 1 | 0 | 4, 9, 14, 19, | 7 | 1 | 1 | 6 |
| | | | | 24, 29, 34, 39 | | | | |
| 84 | A3 | 1 | 0 | 13, 14, 15, 29, | 7 | 2 | 1 | 6 |
| | | | | 30, 31, 37, 38, 39 | | | | |
| 85 | A3 | 1 | 0 | 3, 7, 11, 15, 19, | 7 | 1 | 1 | 6 |
| | | | | 23, 27, 31, 35, 39 | | | | |
| 86 | A3 | 1 | 0 | 3, 7, 11, 15, 19, | 0 | 1 | 2 | 6 |
| | | | | 23, 27, 31, 35, 39 | | | | |
| 87 | A3 | 1 | 0 | 1, 3, 5, 7, ... , | 0 | 1 | 2 | 6 |
| | | | | 37, 39 | | | | |
| 88 | A3 | 1 | 0 | 0, 1, 2, ... , 39 | 7 | 1 | 1 | 6 |
| 89 | B1 | 16 | 1 | 4, 9, 14, 19, | 2 | 2 | 6 | 2 |
| | | | | 24, 29, 34, 39 | | | | |
| 90 | B1 | 8 | 1 | 4, 9, 14, 19, | 2 | 2 | 6 | 2 |
| | | | | 24, 29, 34, 39 | | | | |
| 91 | B1 | 8 | 1, 2 | 9, 19, 29, 39 | 2 | 2 | 6 | 2 |
| 92 | B1 | 4 | 1 | 4, 9, 14, 19, | 2 | 2 | 6 | 2 |
| | | | | 24, 29, 34, 39 | | | | |
| 93 | B1 | 2 | 1 | 4, 9, 14, 19, | 2 | 2 | 6 | 2 |
| | | | | 24, 29, 34, 39 | | | | |
| 94 | B1 | 2 | 1 | 3, 7, 11, 15, 19, | 2 | 1 | 6 | 2 |
| | | | | 23, 27, 31, 35, 39 | | | | |
| 95 | B1 | 1 | 0 | 19, 39 | 8 | 1 | 3 | 2 |
| 96 | B1 | 1 | 0 | 3, 5, 7 | 2 | 1 | 6 | 2 |
| 97 | B1 | 1 | 0 | 24, 29, 34, 39 | 8 | 1 | 3 | 2 |
| 98 | B1 | 1 | 0 | 9, 19, 29, 39 | 8 | 2 | 3 | 2 |
| 99 | B1 | 1 | 0 | 17, 19, 37, 39 | 2 | 1 | 6 | 2 |
| 100 | B1 | 1 | 0 | 9, 19, 29, 39 | 2 | 2 | 6 | 2 |
| 101 | B1 | 1 | 0 | 7, 15, 23, 31, 39 | 2 | 1 | 6 | 2 |
| 102 | B1 | 1 | 0 | 23, 27, 31, 35, 39 | 8 | 1 | 3 | 2 |
| 103 | B1 | 1 | 0 | 23, 27, 31, 35, 39 | 2 | 1 | 6 | 2 |
| 104 | B1 | 1 | 0 | 3, 5, 7, 9, 11, 13 | 8 | 1 | 3 | 2 |
| 105 | B1 | 1 | 0 | 4, 9, 14, 19, | 8 | 1 | 3 | 2 |
| | | | | 24, 29, 34, 39 | | | | |
| 106 | B1 | 1 | 0 | 4, 9, 14, 19, | 2 | 1 | 6 | 2 |
| | | | | 24, 29, 34, 39 | | | | |
| 107 | B1 | 1 | 0 | 3, 7, 11, 15, 19, | 8 | 1 | 3 | 2 |
| | | | | 23, 27, 31, 35, 39 | | | | |
| 108 | B1 | 1 | 0 | 13, 14, 15, 29, | 8 | 2 | 3 | 2 |
| | | | | 30, 31, 37, 38, 39 | | | | |
| 109 | B1 | 1 | 0 | 3, 7, 11, 15, 19, | 2 | 1 | 6 | 2 |
| | | | | 23, 27, 31, 35, 39 | | | | |
| 110 | B1 | 1 | 0 | 1, 3, 5, 7, ... , | 2 | 1 | 6 | 2 |
| | | | | 37, 39 | | | | |
| 111 | B1 | 1 | 0 | 0, 1, 2, ... , 39 | 8 | 1 | 3 | 2 |
| 112 | B4 | 16 | 1, 2 | 4, 9, 14, 19, | 0 | 2 | 1 | 12 |
| | | | | 24, 29, 34, 39 | | | | |
| 113 | B4 | 16 | 1, 2 | 3, 7, 11, 15, 19, | 0 | 1 | 1 | 12 |
| | | | | 23, 27, 31, 35, 39 | | | | |
| 114 | B4 | 8 | 1, 2 | 4, 9, 14, 19, | 0 | 2 | 1 | 12 |
| | | | | 24, 29, 34, 39 | | | | |
| 115 | B4 | 8 | 1, 2 | 3, 7, 11, 15, 19, | 0 | 1 | 1 | 12 |
| | | | | 23, 27, 31, 35, 39 | | | | |
| 116 | B4 | 8 | 1, 2 | 9, 19, 29, 39 | 0 | 2 | 1 | 12 |
| 117 | B4 | 4 | 1 | 4, 9, 14, 19, | 0 | 1 | 1 | 12 |
| | | | | 24, 29, 34, 39 | | | | |
| 118 | B4 | 4 | 1 | 4, 9, 14, 19, | 0 | 2 | 1 | 12 |
| | | | | 24, 29, 34, 39 | | | | |
| 119 | B4 | 4 | 1, 2 | 3, 7, 11, 15, 19, | 0 | 1 | 1 | 12 |
| | | | | 23, 27, 31, 35, 39 | | | | |
| 120 | B4 | 2 | 1 | 7, 15, 23, 31, 39 | 2 | 2 | 1 | 12 |
| 121 | B4 | 2 | 1 | 4, 9, 14, 19, | 0 | 1 | 1 | 12 |
| | | | | 24, 29, 34, 39 | | | | |
| 122 | B4 | 2 | 1 | 4, 9, 14, 19, | 0 | 2 | 1 | 12 |
| | | | | 24, 29, 34, 39 | | | | |
| 123 | B4 | 2 | 1 | 3, 7, 11, 15, 19, | 0 | 1 | 1 | 12 |
| | | | | 23, 27, 31, 35, 39 | | | | |
| 124 | B4 | 1 | 0 | 19, 39 | 2 | 2 | 1 | 12 |
| 125 | B4 | 1 | 0 | 17, 19, 37, 39 | 0 | 1 | 1 | 12 |
| 126 | B4 | 1 | 0 | 24, 29, 34, 39 | 2 | 1 | 1 | 12 |
| 127 | B4 | 1 | 0 | 9, 19, 29, 39 | 2 | 2 | 1 | 12 |
| 128 | B4 | 1 | 0 | 9, 19, 29, 39 | 0 | 2 | 1 | 12 |
| 129 | B4 | 1 | 0 | 7, 15, 23, 31, 39 | 0 | 1 | 1 | 12 |
| 130 | B4 | 1 | 0 | 7, 15, 23, 31, 39 | 0 | 2 | 1 | 12 |
| 131 | B4 | 1 | 0 | 23, 27, 31, 35, 39 | 0 | 1 | 1 | 12 |
| 132 | B4 | 1 | 0 | 23, 27, 31, 35, 39 | 2 | 2 | 1 | 12 |
| 133 | B4 | 1 | 0 | 9, 11, 13, 15, 17, 19 | 0 | 1 | 1 | 12 |
| 134 | B4 | 1 | 0 | 3, 5, 7, 9, 11, 13 | 2 | 1 | 1 | 12 |
| 135 | B4 | 1 | 0 | 4, 9, 14, 19, | 0 | 1 | 1 | 12 |
| | | | | 24, 29, 34, 39 | | | | |
| 136 | B4 | 1 | 0 | 4, 9, 14, 19, | 2 | 2 | 1 | 12 |
| | | | | 24, 29, 34, 39 | | | | |
| 137 | B4 | 1 | 0 | 13, 14, 15, 29, | 2 | 2 | 1 | 12 |
| | | | | 30, 31, 37, 38, 39 | | | | |
| 138 | B4 | 1 | 0 | 3, 7, 11, 15, 19, | 0 | 1 | 1 | 12 |
| | | | | 23, 27, 31, 35, 39 | | | | |
| 139 | B4 | 1 | 0 | 3, 7, 11, 15, 19, | 2 | 1 | 1 | 12 |
| | | | | 23, 27, 31, 35, 39 | | | | |
| 140 | B4 | 1 | 0 | 3, 5, 7, ... , | 2 | 1 | 1 | 12 |
| | | | | 23, 25 | | | | |
| 141 | B4 | 1 | 0 | 3, 5, 7, ... , | 0 | 2 | 1 | 12 |
| | | | | 23, 25 | | | | |
| 142 | B4 | 1 | 0 | 1, 3, 5, 7, ... , | 0 | 1 | 1 | 12 |
| | | | | 37, 39 | | | | |
| 143 | B4 | 1 | 0 | 0, 1, 2, ... , 39 | 2 | 1 | 1 | 12 |
| 144 | C0 | 16 | 1 | 4, 9, 14, 19, | 0 | 2 | 7 | 2 |
| | | | | 24, 29, 34, 39 | | | | |
| 145 | C0 | 16 | 1 | 3, 7, 11, 15, 19, | 0 | 1 | 7 | 2 |
| | | | | 23, 27, 31, 35, 39 | | | | |
| 146 | C0 | 8 | 1 | 4, 9, 14, 19, 24, | | | | |
| | | | | 29, 34, 39 | | | | |
| 147 | C0 | 8 | 1 | 3, 7, 11, 15, 19, | 0 | 1 | 7 | 2 |
| | | | | 23, 27, 31, 35, 39 | | | | |
| 148 | C0 | 8 | 1, 2 | 9, 19, 29, 39 | 0 | 2 | 7 | 2 |
| 149 | C0 | 4 | 1 | 4, 9, 14, 19, | 0 | 1 | 7 | 2 |
| | | | | 24, 29, 34, 39 | | | | |
| 150 | C0 | 4 | 1 | 4, 9, 14, 19, | 0 | 2 | 7 | 2 |
| | | | | 24, 29, 34, 39 | | | | |
| 151 | C0 | 4 | 1 | 3, 7, 11, 15, 19, | 0 | 1 | 7 | 2 |
| | | | | 23, 27, 31, 35, 39 | | | | |
| 152 | C0 | 2 | 1 | 7, 15, 23, 31, 39 | 0 | 2 | 7 | 2 |
| 153 | C0 | 2 | 1 | 4, 9, 14, 19, | 0 | 1 | 7 | 2 |
| | | | | 24, 29, 34, 39 | | | | |
| 154 | C0 | 2 | 1 | 4, 9, 14, 19, | 0 | 2 | 7 | 2 |
| | | | | 24, 29, 34, 39 | | | | |
| 155 | C0 | 2 | 1 | 3, 7, 11, 15, 19, | 0 | 1 | 7 | 2 |
| | | | | 23, 27, 31, 35, 39 | | | | |
| 156 | C0 | 1 | 0 | 19, 39 | 8 | 1 | 3 | 2 |
| 157 | C0 | 1 | 0 | 3, 5, 7 | 0 | 1 | 7 | 2 |
| 158 | C0 | 1 | 0 | 24, 29, 34, 39 | 8 | 1 | 3 | 2 |
| 159 | C0 | 1 | 0 | 9, 19, 29, 39 | 8 | 2 | 3 | 2 |
| 160 | C0 | 1 | 0 | 17, 19, 37, 39 | 0 | 1 | 7 | 2 |
| 161 | C0 | 1 | 0 | 9, 19, 29, 39 | 0 | 2 | 7 | 2 |
| 162 | C0 | 1 | 0 | 23, 27, 31, 35, 39 | 8 | 1 | 3 | 2 |
| 163 | C0 | 1 | 0 | 7, 15, 23, 31, 39 | 0 | 1 | 7 | 2 |
| 164 | C0 | 1 | 0 | 23, 27, 31, 35, 39 | 0 | 1 | 7 | 2 |
| 165 | C0 | 1 | 0 | 3, 5, 7, 9, 11, 13 | 8 | 1 | 3 | 2 |
| 166 | C0 | 1 | 0 | 4, 9, 14, 19, | 8 | 1 | 3 | 2 |
| | | | | 24, 29, 34, 39 | | | | |
| 167 | C0 | 1 | 0 | 4, 9, 14, 19, | 0 | 1 | 7 | 2 |
| | | | | 24, 29, 34, 39 | | | | |
| 168 | C0 | 1 | 0 | 13, 14, 15, 29, | 8 | 2 | 3 | 2 |
| | | | | 30, 31, 37, 38, 39 | | | | |
| 169 | C0 | 1 | 0 | 3, 7, 11, 15, 19, | 8 | 1 | 3 | 2 |
| | | | | 23, 27, 31, 35, 39 | | | | |
| 170 | C0 | 1 | 0 | 3, 7, 11, 15, 19, | 0 | 1 | 7 | 2 |
| | | | | 23, 27, 31, 35, 39 | | | | |
| 171 | C0 | 1 | 0 | 1, 3, 5, 7, ... , | 0 | 1 | 7 | 2 |
| | | | | 37, 39 | | | | |
| 172 | C0 | 1 | 0 | 0, 1, 2, ... , 39 | 8 | 1 | 3 | 2 |
| 173 | C2 | 16 | 1 | 4, 9, 14, 19, | 0 | 2 | 2 | 6 |
| | | | | 24, 29, 34, 39 | | | | |
| 174 | C2 | 16 | 1 | 3, 7, 11, 15, 19, | 0 | 1 | 2 | 6 |
| | | | | 23, 27, 31, 35, 39 | | | | |
| 175 | C2 | 8 | 1 | 4, 9, 14, 19, | 0 | 2 | 2 | 6 |
| | | | | 24, 29, 34, 39 | | | | |
| 176 | C2 | 8 | 1 | 3, 7, 11, 15, 19, | 0 | 1 | 2 | 6 |
| | | | | 23, 27, 31, 35, 39 | | | | |
| 177 | C2 | 8 | 1, 2 | 9, 19, 29, 39 | 0 | 2 | 2 | 6 |
| 178 | C2 | 4 | 1 | 4, 9, 14, 19, | 0 | 1 | 2 | 6 |
| | | | | 24, 29, 34, 39 | | | | |
| 179 | C2 | 4 | 1 | 4, 9, 14, 19, | 0 | 2 | 2 | 6 |
| | | | | 24, 29, 34, 39 | | | | |
| 180 | C2 | 4 | 1 | 3, 7, 11, 15, 19, | 0 | 1 | 2 | 6 |
| | | | | 23, 27, 31, 35, 39 | | | | |
| 181 | C2 | 2 | 1 | 7, 15, 23, 31, 39 | 2 | 2 | 2 | 6 |
| 182 | C2 | 2 | 1 | 4, 9, 14, 19, | 0 | 1 | 2 | 6 |
| | | | | 24, 29, 34, 39 | | | | |
| 183 | C2 | 2 | 1 | 4, 9, 14, 19, | 0 | 2 | 2 | 6 |
| | | | | 24, 29, 34, 39 | | | | |
| 184 | C2 | 2 | 1 | 3, 7, 11, 15, 19, | 0 | 1 | 2 | 6 |
| | | | | 23, 27, 31, 35, 39 | | | | |
| 185 | C2 | 1 | 0 | 19, 39 | 2 | 1 | 2 | 6 |
| 186 | C2 | 1 | 0 | 3, 5, 7 | 0 | 1 | 2 | 6 |
| 187 | C2 | 1 | 0 | 24, 29, 34, 39 | 7 | 1 | 1 | 6 |
| 188 | C2 | 1 | 0 | 9, 19, 29, 39 | 7 | 2 | 1 | 6 |
| 189 | C2 | 1 | 0 | 17, 19, 37, 39 | 0 | 1 | 2 | 6 |
| 190 | C2 | 1 | 0 | 9, 19, 29, 39 | 2 | 2 | 2 | 6 |
| 191 | C2 | 1 | 0 | 7, 15, 23, | 2 | 1 | 2 | 6 |
| | | | | 31, 39 | | | | |
| 192 | C2 | 1 | 0 | 3, 5, 7, 9, 11, 13 | 7 | 1 | 1 | 6 |
| 193 | C2 | 1 | 0 | 23, 27, 31, 35, 39 | 7 | 2 | 1 | 6 |
| 194 | C2 | 1 | 0 | 23, 27, 31, 35, 39 | 0 | 1 | 2 | 6 |
| 195 | C2 | 1 | 0 | 4, 9, 14, 19, 24, | 7 | 2 | 1 | 6 |
| | | | | 29, 34, 39 | | | | |
| 196 | C2 | 1 | 0 | 4, 9, 14, 19, | 2 | 1 | 2 | 6 |
| | | | | 24, 29, 34, 39 | | | | |
| 197 | C2 | 1 | 0 | 13, 14, 15, 29, | 7 | 2 | 1 | 6 |
| | | | | 30, 31, 37, 38, 39 | | | | |
| 198 | C2 | 1 | 0 | 3, 7, 11, 15, 19, | 7 | 1 | 1 | 6 |
| | | | | 23, 27, 31, 35, 39 | | | | |
| 199 | C2 | 1 | 0 | 3, 7, 11, 15, 19, | 0 | 1 | 2 | 6 |
| | | | | 23, 27, 31, 35, 39 | | | | |
| 200 | C2 | 1 | 0 | 1, 3, 5, 7, ... , | 0 | 1 | 2 | 6 |
| | | | | 37, 39 | | | | |
| 201 | C2 | 1 | 0 | 0, 1, 2, ... , 39 | 7 | 1 | 1 | 6 |
| 202 | A1/B1 | 16 | 1 | 4, 9, 14, 19, 24, | 2 | 1 | 6 | 2 |
| | | | | 29, 34, 39 | | | | |
| 203 | A1/B1 | 16 | 1 | 3, 7, 11, 15, 19, | 2 | 1 | 6 | 2 |
| | | | | 23, 27, 31, 35, 39 | | | | |
| 204 | A1/B1 | 8 | 1 | 4, 9, 14, 19, | 2 | 1 | 6 | 2 |
| | | | | 24, 29, 34, 39 | | | | |
| 205 | A1/B1 | 8 | 1 | 3, 7, 11, 15, 19, | 2 | 1 | 6 | 2 |
| | | | | 23, 27, 31, 35, 39 | | | | |
| 206 | A1/B1 | 4 | 1 | 4, 9, 14, 19, | 2 | 1 | 6 | 2 |
| | | | | 24, 29, 34, 39 | | | | |
| 207 | A1/B1 | 4 | 1 | 3, 7, 11, 15, 19, | 2 | 1 | 6 | 2 |
| | | | | 23, 27, 31, 35, 39 | | | | |
| 208 | A1/B1 | 2 | 1 | 4, 9, 14, 19, 24, | 2 | 1 | 6 | 2 |
| | | | | 29, 34, 39 | | | | |
| 209 | A1/B1 | 1 | 0 | 19, 39 | 8 | 1 | 3 | 2 |
| 210 | A1/B1 | 1 | 0 | 9, 19, 29, 39 | 8 | 1 | 3 | 2 |
| 211 | A1/B1 | 1 | 0 | 17, 19, 37, 39 | 2 | 1 | 6 | 2 |
| 212 | A1/B1 | 1 | 0 | 9, 19, 29, 39 | 2 | 2 | 6 | 2 |
| 213 | A1/B1 | 1 | 0 | 23, 27, 31, 35, 39 | 8 | 1 | 3 | 2 |
| 214 | A1/B1 | 1 | 0 | 7, 15, 23, 31, 39 | 2 | 1 | 6 | 2 |
| 215 | A1/B1 | 1 | 0 | 23, 27, 31, 35, 39 | 2 | 1 | 6 | 2 |
| 216 | A1/B1 | 1 | 0 | 4, 9, 14, 19, | 8 | 1 | 3 | 2 |
| | | | | 24, 29, 34, 39 | | | | |
| 217 | A1/B1 | 1 | 0 | 4, 9, 14, 19, | 2 | 1 | 6 | 2 |
| | | | | 24, 29, 34, 39 | | | | |
| 218 | A1/B1 | 1 | 0 | 3, 7, 11, 15, 19, | 2 | 1 | 6 | 2 |
| | | | | 23, 27, 31, 35, 39 | | | | |
| 219 | A1/B1 | 1 | 0 | 1, 3, 5, 7, ... , | 2 | 1 | 6 | 2 |
| | | | | 37, 39 | | | | |
| 220 | A2/B2 | 16 | 1 | 4, 9, 14, 19, | 2 | 1 | 3 | 4 |
| | | | | 24, 29, 34, 39 | | | | |
| 221 | A2/B2 | 16 | 1 | 3, 7, 11, 15, 19, | 2 | 1 | 3 | 4 |
| | | | | 23, 27, 31, 35, 39 | | | | |
| 222 | A2/B2 | 8 | 1 | 4, 9, 14, 19, | 2 | 1 | 3 | 4 |
| | | | | 24, 29, 34, 39 | | | | |
| 223 | A2/B2 | 8 | 1 | 3, 7, 11, 15, 19, | 2 | 1 | 3 | 4 |
| | | | | 23, 27, 31, 35, 39 | | | | |
| 224 | A2/B2 | 4 | 1 | 4, 9, 14, 19, | 2 | 1 | 3 | 4 |
| | | | | 24, 29, 34, 39 | | | | |
| 225 | A2/B2 | 4 | 1 | 3, 7, 11, 15, 19, | 2 | 1 | 3 | 4 |
| | | | | 23, 27, 31, 35, 39 | | | | |
| 226 | A2/B2 | 2 | 1 | 4, 9, 14, 19, | 2 | 1 | 3 | 4 |
| | | | | 24, 29, 34, 39 | | | | |
| 227 | A2/B2 | 1 | 0 | 19, 39 | 6 | 1 | 2 | 4 |
| 228 | A2/B2 | 1 | 0 | 9, 19, 29, 39 | 6 | 1 | 2 | 4 |
| 229 | A2/B2 | 1 | 0 | 17, 19, 37, 39 | 2 | 1 | 3 | 4 |
| 230 | A2/B2 | 1 | 0 | 9, 19, 29, 39 | 2 | 2 | 3 | 4 |
| 231 | A2/B2 | 1 | 0 | 23, 27, 31, 35, 39 | 6 | 1 | 2 | 4 |
| 232 | A2/B2 | 1 | 0 | 7, 15, 23, 31, 39 | 2 | 1 | 3 | 4 |
| 233 | A2/B2 | 1 | 0 | 23, 27, 31, 35, 39 | 2 | 1 | 3 | 4 |
| 234 | A2/B2 | 1 | 0 | 4, 9, 14, 19, | 6 | 1 | 2 | 4 |
| | | | | 24, 29, 34, 39 | | | | |
| 235 | A2/B2 | 1 | 0 | 4, 9, 14, 19, | 2 | 1 | 3 | 4 |
| | | | | 24, 29, 34, 39 | | | | |
| 236 | A2/B2 | 1 | 0 | 3, 7, 11, 15, 19, | 2 | 1 | 3 | 4 |
| | | | | 23, 27, 31, 35, 39 | | | | |
| 237 | A2/B2 | 1 | 0 | 1, 3, 5, 7, ... , | 2 | 1 | 3 | 4 |
| | | | | 37, 39 | | | | |
| 238 | A3/B3 | 16 | 1 | 4, 9, 14, 19, | 2 | 1 | 2 | 6 |
| | | | | 24, 29, 34, 39 | | | | |
| 239 | A3/B3 | 16 | 1 | 3, 7, 11, 15, 19, | 2 | 1 | 2 | 6 |
| | | | | 23, 27, 31, 35, 39 | | | | |
| 240 | A3/B3 | 8 | 1 | 4, 9, 14, 19, | 2 | 1 | 2 | 6 |
| | | | | 24, 29, 34, 39 | | | | |
| 241 | A3/B3 | 8 | 1 | 3, 7, 11, 15, 19, | 2 | 1 | 2 | 6 |
| | | | | 23, 27, 31, 35, 39 | | | | |
| 242 | A3/B3 | 4 | 1 | 4, 9, 14, 19, | 2 | 1 | 2 | 6 |
| | | | | 24, 29, 34, 39 | | | | |
| 243 | A3/B3 | 4 | 1 | 3, 7, 11, 15, 19, | 2 | 1 | 2 | 6 |
| | | | | 23, 27, 31, 35, 39 | | | | |
| 244 | A3/B3 | 2 | 1 | 4, 9, 14, 19, | 2 | 1 | 2 | 6 |
| | | | | 24, 29, 34, 39 | | | | |
| 245 | A3/B3 | 1 | 0 | 19, 39 | 2 | 1 | 2 | 6 |
| 246 | A3/B3 | 1 | 0 | 9, 19, 29, 39 | 2 | 1 | 2 | 6 |
| 247 | A3/B3 | 1 | 0 | 17, 19, 37, 39 | 2 | 1 | 2 | 6 |
| 248 | A3/B3 | 1 | 0 | 9, 19, 29, 39 | 2 | 2 | 2 | 6 |
| 249 | A3/B3 | 1 | 0 | 7, 15, 23, 31, 39 | 2 | 1 | 2 | 6 |
| 250 | A3/B3 | 1 | 0 | 23, 27, 31, 35, 39 | 2 | 1 | 2 | 6 |
| 251 | A3/B3 | 1 | 0 | 23, 27, 31, 35, 39 | 2 | 2 | 2 | 6 |
| 252 | A3/B3 | 1 | 0 | 4, 9, 14, 19, | 2 | 1 | 2 | 6 |
| | | | | 24, 29, 34, 39 | | | | |
| 253 | A3/B3 | 1 | 0 | 4, 9, 14, 19, | 2 | 2 | 2 | 6 |
| | | | | 24, 29, 34, 39 | | | | |
| 254 | A3/B3 | 1 | 0 | 3, 7, 11, 15, 19, | 2 | 1 | 2 | 6 |
| | | | | 23, 27, 31, 35, 39 | | | | |
| 255 | A3/B3 | 1 | 0 | 1, 3, 5, 7, ... , | 2 | 1 | 2 | 6 |
| | | | | 37, 39 | | | | |

For example, in embodiments described below, the ROs may be ROs based on one of Tables 2 to 4 above.

The contents described above can be applied by being combined with methods according to the present disclosure described below, or can be supplemented to clarify technical features of methods described in the present disclosure.

In addition, methods related to configuration of a PRACH transmission occasion described below are related to uplink transmission and can be equally applied to an uplink signal transmission method in the NR system (licensed band) or U-Band system (unlicensed band) described above. The technical ideas described in the present disclosure can be modified or replaced to suit terms, expressions, structures, etc. defined in each system so that they can be implemented in the corresponding systems.

For example, the uplink transmission through the methods related to configuration of the PRACH transmission occasion described below can be performed in an L-cell (cell operating in the licensed band (L-band)) and/or a U-cell (cell operating in the unlicensed band (U-band)) defined in the NR system or the U-Band system.

NR supports multiple numerologies (or subcarrier spacing (SCS)) for supporting diverse 5G services. For example, if the SCS is 15 kHz, the NR supports a wide area in conventional cellular bands; if the SCS is 30 kHz/60 kHz, the NR supports a dense-urban, lower latency and wider carrier bandwidth; and if the SCS is 60 kHz or higher, the NR supports a bandwidth greater than 24.25 GHz to overcome phase noise.

An NR frequency band is defined as two types of frequency ranges FR1 and FR2. FR1 and FR2 may be configured as shown in Table 5 below. FR2 may mean millimeter wave (mmW).

TABLE 5

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Hereinafter, when a PRACH repetition scheme is introduced for coverage enhancement in NR, a RACH resource partitioning method for PRACH repetition and a related UE/base station operation are proposed. In the present disclosure, ‘PRACH transmission’, ‘RACH transmission’ or ‘preamble transmission’ may be interpreted/replaced as ‘MSG1 transmission’.

Various RAN1 work items are defined to distinguish UE/base station operations based on a RACH resource (e.g., PRACH preamble index, etc.). As an example, UEs related to redcap, small data transmission, Msg. 3 PUSCH repetition, etc., are defined to select a specific preamble index to request from the base station whether to use a corresponding feature in a PRACH preamble transmission step. However, when each operation separately created for each work item are defined, an implementation complexity of the UE/base station may be increased.

Therefore, a concept of “Feature Combination” has been introduced to efficiently support UE/base station operations that need to be distinguished by using the RACH resource (e.g., PRACH preamble index, etc.) in a RAN2 Rel-17 RACH partitioning work item. That is, the base station configures/indicates to the UE that a specific feature or a combination of specific features is supported by configuring a specific PRACH resource (e.g., preamble start index and total number indication). The UE that intends to use/request a specific feature and/or a combination of specific features may select one of preamble indices of a region allocated to the specific feature and/or the combination of the specific features desired by itself during the RACH procedure to transmit a PRACH preamble. RRC parameters for this operation may be “FeatureCombinationPreambles” and “FeatureCombination”. Table 6 below shows the “FeatureCombinationPreambles” and “FeatureCombination”.

TABLE 6
FeatureCombinationPreambles-r17 ::= SEQUENCE {

| | |
|---|---|
| featureCombination-r17 | FeatureCombination-r17, |
| startPreambleForThisPartition-r17 | INTEGER (1..64), |

numberOfPreamblesPerSSB-ForThisPartition-r17 INTEGER (1..64),

| | |
|---|---|
| ssb-SharedRO-MaskIndex-r17 | INTEGER (1..15) |

OPTIONAL, -- Need S

| | |
|---|---|
| groupBconfigured-r17 | SEQUENCE { |
| ra-SizeGroupA-r17 | ENUMERATED {b56, b144, b208, |

b256, b282, b480, b640, b800, b1000, b72, spare6, spare5, spare4, spare3,
spare2, spare1},

| | |
|---|---|
| messagePowerOffsetGroupB | ENUMERATED { minusinfinity, |

dB0, dB5, dB8, dB10, dB12, dB15, dB18},

| | |
|---|---|
| numberOfRA-PreamblesGroupA | INTEGER (1..64) |
| } | OPTIONAL, -- Need S |
| separateMsgA-PUSCH-Config-r17 | MsgA-PUSCH-Config-r16 |

OPTIONAL, -- Cond MsgAConfigCommon

| | |
|---|---|
| msgA-RSRP-Threshold-r17 | RSRP-Range |

OPTIONAL, -- Need R

| | | |
|---|---|---|
| rsrp-ThresholdSSB-r17 | RSRP-Range | OPTIONAL, |

-- Need R

| | | |
|---|---|---|
| deltaPreamble-r17 | INTEGER (−1..6) | OPTIONAL, -- |

Need R
...
}
FeatureCombination-r17 ::= SEQUENCE {

| | | |
|---|---|---|
| redCap-r17 | ENUMERATED {true} | OPTIONAL, |

-- Need R

| | | |
|---|---|---|
| smallData-r17 | ENUMERATED {true} | OPTIONAL, |

-- Need R

| | | |
|---|---|---|
| nsag-r17 | NSAG-List-r17 | OPTIONAL, -- Need |

R

| | |
|---|---|
| msg3-Repetitions-r17 | ENUMERATED {true} |

OPTIONAL, -- Need R

| | | |
|---|---|---|
| spare4 | ENUMERATED {true} | OPTIONAL, -- |

Need R

| | | |
|---|---|---|
| spare3 | ENUMERATED {true} | OPTIONAL, -- |

Need R

| | | |
|---|---|---|
| spare2 | ENUMERATED {true} | OPTIONAL, -- |

Need R

| | | |
|---|---|---|
| spare1 | ENUMERATED {true} | OPTIONAL -- |

Need R
}

A plurality of FeatureCombinationPreambles parameters may be configured within RACH-ConfigCommon. Preamble index intervals corresponding to each region (i.e., a region/partition based on a preamble(s) belonging to each of the plurality of FeatureCompanyPreamble parameters) need to be configured not to overlap. In addition, features and/or combinations of features configured in respective regions also need to be configured to not overlap with each other. As described above, the parameter(s) for the random access procedure may be initialized/determined based on the RACH resource(s) (e.g., preamble(s)) selected by the UE.

In the present disclosure, a ‘RACH resource’ (or ‘PRACH resource’) may be interpreted/replaced as a random access resource. For example, a FeatureCombination (e.g., a feature or a combination of features) related to RACH resources may be interpreted/replaced as FeatureCombination related to a set of random access resources.

In addition to the RACH-ConfigCommon allocated to existing BWP-UplinkCommon, the base station may additionally allocate a RACH configuration through AdditionalRACH-Config-r17. The BWP-UplinkCommon may be configured based on an SIB (e.g., SIB1). The RACH procedure may be performed as follows by a Rel-16 UE/Rel-17 UE.

For Rel-16 UEs that may not read AdditionalRACH-Config-r17, the UEs perform the RACH procedure based on RACH-ConfigCommon allocated to BWP-UplinkCommon.

For UEs of Rel-17 and later that may read AdditionalRACH-Config-r17, the UEs perform the RACH procedure by confirming RACH-ConfigCommon allocated to the existing BWP-UplinkCommon and RACH-ConfigCommon allocated to the AdditionalRACH-Config-r17.

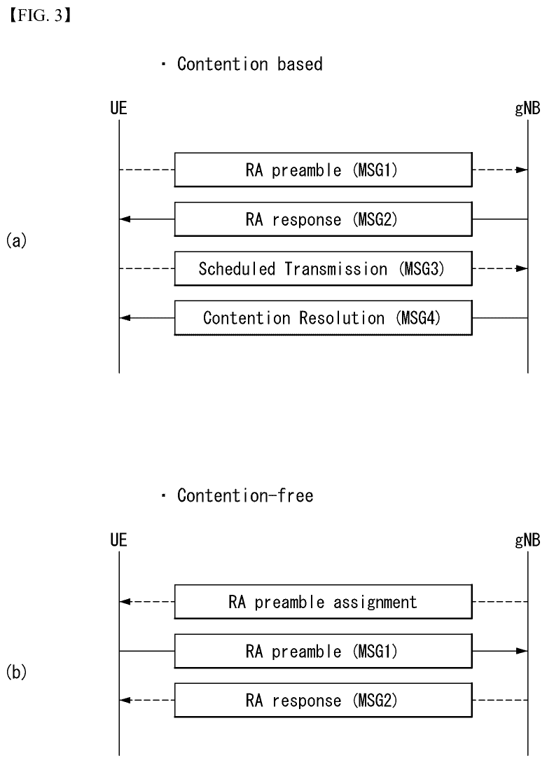

In addition, one or more FeatureCombinationPreambles described above may be configured in the RACH-ConfigCommon allocated to the existing BWP-UplinkCommon. One or more FeatureCombinationPreambles described above may be also configured in the RACH-ConfigCommon allocated to the AdditionalRACH-Config-r17. Hereinafter, this will be described with reference to FIG. 4.

FIG. 4 illustrates an RACH partitioning related RRC parameter. Specifically, FIG. 4 illustrates a connection relationship/up-and-down relationship of the RACH partitioning related RRC parameters.

Respective parameters will be specifically described with reference to FIG. 4. For convenience of description, an RRC parameter (e.g., BWP-UplinkCommon parameter) is described as a parameter name (e.g., BWP-UplinkCommon).

The BWP-UplinkCommon includes i) rach-ConfigCommon, ii) msgA-ConfigCommon, and iii) one or more AdditionalRACH-Config #1, #2, . . . .

Each AdditionalRACH-Config includes i) rach-ConfigCommon and ii) msgA-ConfigCommo.

Each rach-ConfigCommon includes one or more FeatureConbinationPreambles.

Each FeatureConbinationPreambles includes FeatureCombination.

Table 7 shows the RRC parameters described above.

TABLE 7
- BWP-UplinkCommon
The IE BWP-UplinkCommon is used to configure the common parameters of an
uplink BWP. They are “cell specific” and the network ensures the necessary
alignment with corresponding parameters of other UEs. The common parameters
of the initial bandwidth part of the PCell are also provided via system information.
For all other serving cells, the network provides the common parameters via
dedicated signalling.

| | |
|---|---|
| BWP-UplinkCommon ::= | SEQUENCE { |

| | |
|---|---|
| genericParameters | BWP, |

| | |
|---|---|
| rach-ConfigCommon | SetupRelease { RACH-ConfigCommon } |

OPTIONAL, -- Need M

| | |
|---|---|
| pusch-ConfigCommon | SetupRelease { PUSCH-ConfigCommon } |

OPTIONAL, -- Need M

| | |
|---|---|
| pucch-ConfigCommon | SetupRelease { PUCCH-ConfigCommon } |

```
OPTIONAL, -- Need M
  ...,
  [[
```

| | |
|---|---|
| rach-ConfigCommonIAB-r16 | SetupRelease { RACH- |
| ConfigCommon } | OPTIONAL, -- Need M |
| useInterlacePUCCH-PUSCH-r16 | ENUMERATED {enabled} |

OPTIONAL, -- Need R

| | |
|---|---|
| msgA-ConfigCommon-r16 | SetupRelease { MsgA-ConfigCommon- |

| | |
|---|---|
| r16 } | OPTIONAL -- Cond SpCellOnly2 |

```
  ]],
  [[
  enableRA-PrioritizationForSlicing-r17 BOOLEAN
OPTIONAL, -- Cond RA-PrioSliceAI
```

| | |
|---|---|
| additionalRACH-ConfigList-r17 | SetupRelease { AdditionalRACH- |

| | |
|---|---|
| ConfigList-r17 } | OPTIONAL, -- Cond SpCellOnly2 |

| | |
|---|---|
| rsrp-ThresholdMsg3-r17 | RSRP-Range |

OPTIONAL, -- Need R

| | |
|---|---|
| numberOfMsg3-RepetitionsList-r17 | SEQUENCE (SIZE (4)) OF |
| NumberOfMsg3-Repetitions-r17 | OPTIONAL, -- Cond Msg3Rep |
| mcs-Msg3-Repetitions-r17 | SEQUENCE (SIZE (8)) OF INTEGER |

| | |
|---|---|
| (0..31) | OPTIONAL -- Cond Msg3Rep |

```
  ]],
  [[
  additionalRACH-perPCI-ToAddModList-r18 SEQUENCE (SIZE (1..
maxNrofAdditionalPRACHConfigs-r18)) OF RACH-ConfigTwoTA-r18
```

OPTIONAL,

-- Cond 2TA-Only
additionalRACH-perPCI-ToReleaseList-r18 SEQUENCE (SIZE (1..
maxNrofAdditionalPRACHConfigs-r18)) OF RACH-ConfigTwoTAIndex-r18
OPTIONAL, -- Need N

| | |
|---|---|
| rsrp-ThresholdMsg1-RepetitionNum2-r18 | RSRP-Range |

OPTIONAL, -- Cond Msg1Rep1

| | |
|---|---|
| rsrp-ThresholdMsg1-RepetitionNum4-r18 | RSRP-Range |

OPTIONAL, -- Cond Msg1Rep1

| | |
|---|---|
| rsrp-ThresholdMsg1-RepetitionNum8-r18 | RSRP-Range |

OPTIONAL, -- Cond Msg1Rep1

| | |
|---|---|
| preambleTransMax-Msg1-Repetition-r18 | ENUMERATED {n1, n2, n4, |

| | |
|---|---|
| n6, n8, n10, n20, n50, n100, n200} | OPTIONAL -- Cond Msg1Rep1 |

]]
}

| | |
|---|---|
| AdditionalRACH-ConfigList-r17 ::= | SEQUENCE |

(SIZE(1..maxAdditionalRACH-r17)) OF AdditionalRACH-Config-r17

| | |
|---|---|
| AdditionalRACH-Config-r17 ::= | SEQUENCE { |
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Need R
...
}

| | |
|---|---|
| NumberOfMsg3-Repetitions-r17::= | ENUMERATED {n1, n2, n3, n4, n7, |

n8, n12, n16}

| BWP-UplinkCommon field descriptions | |
|---|---|
| additionalRACH-ConfigList | |
| List of feature or feature combination-specific RACH configurations, i.e. the | |
| RACH configurations configured in addition to the one configured by rach- | |
| ConfigCommon and by msgA-ConfigCommon. The network associates all | |
| possible preambles of an additional RACH configuration to one or more | |
| feature(s) or feature combination(s). The network does not configure this list to | |
| have more than 32 entries. If both rach-ConfigCommon and msgA- | |
| ConfigCommon are configured for a specific FeatureCombination, the network | |
| always provides them in the same additionalRACH-Config. | |
| additionalRACH-perPCI-ToAddModList | |
| List of RACH configurations for the additional PCIs. The RACH configuration | |
| for an additional PCI is applied for Random Access procedure initiated by | |
| PDCCH order towards to the additional PCI, as specified in TS 38.321 clause | |
| 5.1.1b. This configuration may be different for different UEs. | |
| enableRA-PrioritizationForSlicing | |
| Indicates whether or not the ra-PrioritizationForSlicing/ra- | |
| PrioritizationForSlicingTwoStep should override the ra- | |
| PrioritizationForAccessIdentity. The field is applicable only when the UE is | |
| configured by upper layers with both NSAG and Access Identity 1 or 2. If | |
| value TRUE is configured, the UE should only apply the ra- | |
| PrioritizationForSlicing/ra-PrioritizationForSlicingTwoStep. If value FALSE | |
| is configured, the UE should only apply ra-PrioritizationForAccessIdentity. If | |
| the field is absent, whether to use ra-PrioritizationForSlicing/ra- | |
| PrioritizationForSlicingTwoStep or ra-PrioritizationForAccessIdentity is up to | |
| UE implementation. | |
| mcs-Msg3-Repetitions | |
| Configuration of eight candidate MCS indexes for PUSCH transmission | |
| scheduled by RAR UL grant and DCI format 0_0 with CRC scrambled by TC- | |
| RNTI. Only the first 4 configured or default MCS indexes are used for PUSCH | |
| transmission scheduled by RAR UL grant. This field is only applicable when | |
| the UE selects Random Access resources indicating Msg3 repetition in this | |
| BWP. If this field is absent when the set(s) of Random Access resources with | |
| MSG3 repetition indication are configured in the BWP-UplinkCommon, the UE | |
| shall apply the values {0, 1, 2, 3, 4, 5, 6, 7} (see TS 38.214 [19], clause 6.1.4). | |
| msgA-ConfigCommon | |
| Configuration of the cell specific PRACH and PUSCH resource parameters for | |
| transmission of MsgA in 2-step random access type procedure. The NW can | |
| configure msgA-ConfigCommon only for UL BWPs if the linked DL BWPs | |
| (same bwp-Id as UL-BWP) are the initial DL BWPs or DL BWPs containing | |
| the SSB associated to the initial DL BWP or DL BWPs associated with | |
| nonCellDefiningSSB or, for (e)RedCap UEs, the (e)RedCap-specific initial | |
| downlink BWP. | |
| numberOfMsg3-RepetitionsList | |
| The number of repetitions for PUSCH transmission scheduled by RAR UL | |
| grant and DCI format 0_0 with CRC scrambled by TC-RNTI. This field is only | |
| applicable when the UE selects Random Access resources indicating Msg3 | |
| repetition in this BWP. If this field is absent when the set(s) of Random Access | |
| resources with MSG3 repetition indication are configured in the BWP- | |
| UplinkCommon, the UE shall apply the values {n1, n2, n3, n4} (see TS 38.214 | |
| [19], clause 6.1.2.1). | |
| preambleTransMax-Msg1-Repetition | |
| Max number of transmissions of MSG1 repetitions number (2, 4 and 8) | |
| performed before switching to higher repetition number (see TS 38.321 [3], | |
| clauses 5.1.1). This field is only applicable when more than one repetition | |
| numbers are configured in shared RO. If the field is absent, switching from | |
| lower repetition number to higher repetition number is not allowed. | |
| pucch-ConfigCommon | |
| Cell specific parameters for the PUCCH of this BWP. | |
| pusch-ConfigCommon | |
| Cell specific parameters for the PUSCH of this BWP. | |
| rach-ConfigCommon | |
| Configuration of cell specific random access parameters which the UE uses for | |
| contention based and contention free random access as well as for contention | |
| based beam failure recovery in this BWP. The NW configures SSB-based RA | |
| (and hence RACH-ConfigCommon) only for UL BWPs if the linked DL BWPs | |
| (same bwp-Id as UL-BWP) are the initial DL BWPs or DL BWPs containing | |
| the SSB associated to the initial DL BWP or DL BWPs associated with | |
| nonCellDefiningSSB or, for (e)RedCap UEs, the (e)RedCap-specific initial | |
| downlink BWP. The network configures rach-ConfigCommon, whenever it | |
| configures contention free random access (for reconfiguration with sync or for | |
| beam failure recovery). For (e)RedCap-specific initial uplink BWP, rach- | |
| ConfigCommon is always configured when msgA-ConfigCommon is | |
| configured in this BWP. | |
| rach-ConfigCommonIAB | |
| Configuration of cell specific random access parameters for the IAB-MT. The | |
| IAB specific IAB RACH configuration is used by IAB-MT, if configured. | |
| rsrp-THresholdMsg1-RepetitionNum2, rsp-THresholdMsg1-repetitionNum4, | |
| rsrp-ThresholdMsg1-RepetitionNum8 | |
| Threshold used by the UE for determining whether to select resources indicating | |
| Msg1 repetition number 2, 4 or 8 in this BWP, as specified in TS 38.321 [3]. | |
| The value applies to all the BWPs and all RACH configurations. This field is | |
| mandatory if both set(s) of Random Access resources with MSG1 repetition | |
| indication and set(s) of Random Access resources without MSG1 repetition | |
| indication are configured in the BWP, or if all set(s) of Random Access | |
| resources are configured with MSG1 repetition indication but associated with | |
| different repetition numbers in the BWP. It is absent otherwise. | |
| rsrp-ThresholdMsg3 | |
| Threshold used by the UE for determining whether to select resources indicating | |
| Msg3 repetition in this BWP, as specified in TS 38.321 [3]. The field is | |
| mandatory if both set(s) of Random Access resources with MSG3 repetition | |
| indication and set(s) of Random Access resources without MSG3 repetition | |
| indication are configured in the BWP. It is absent otherwise. | |
| useInterlacePUCCH-PUSCH | |
| If the field is present, the UE uses uplink frequency domain resource allocation | |
| Type 2 for cell-specific PUSCH, e.g., PUSCH scheduled by RAR UL grant (see | |
| TS 38.213 [13] clause 8.3 and TS 38.214 [19], clause 6.1.2.2) and uses | |
| interlaced PUCCH Format 0 and 1 for cell-specific PUCCH (see TS 38.213 | |
| [13], clause 9.2.1). | |
| Conditional | |
| Presence | Explanation |
| Msg1Rep1 | This field is optionally present, Need R, if the set(s) of |
| | Random Access resources with MSG1 repetition |
| | indication are configured in the BWP-UplinkCommon. It |
| | is absent otherwise. |
| Msg3Rep | This field is optionally present, Need S, if the set(s) of |
| | Random Access resources with MSG3 repetition |
| | indication are configured in the BWP-UplinkCommon. It |
| | is absent otherwise. |
| RA-PrioSliceAI | The field is optionally present in SIB1, Need R, if both |
| | parameters ra-PrioritizationForAccessIdentity and the |
| | ra-PrioritizationForSlicing/ra- |
| | PrioritizationForSlicingTwoStep are present in SIB1. It |
| | is absent otherwise. |
| SpCellOnly2 | The field is optionally present, Need M, in the BWP- |
| | UplinkCommon of an SpCell. It is absent otherwise. |
| 2TA-Only | The field is optionally present, Need N in the BWP- |
| | UplinkCommon if additionalPCI-ToAddModList is |
| | present in spCellConfigDedicated or |
| | sCellConfigDedicated and it has the same number of |
| | entries as the additionalPCI-ToAddModList. It is absent |
| | otherwise. |

- RACH-ConfigCommon
The IE RACH-ConfigCommon is used to specify the cell specific random-access
parameters

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S
ssb-perRACH-OccasionAndCB-PreamblePerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

| | |
|---|---|
| } | OPTIONAL, |

-- Need M

| | |
|---|---|
| groupBconfigured | SEQUENCE { |
| ra-Msg3SizeGroupA | ENUMERATED {b56, b144, b208, b256, |

b282, b480, b640,

b800, b1000, b72, spare6, spare5,spare4,

spare3, spare2, spare1},

| | |
|---|---|
| messagePowerOffsetGroupB | ENUMERATED { minusinfinity, |

dB0, dB5, dB8, dB10, dB12, dB15, dB18},

| | |
|---|---|
| numberOfRA-PreamblesGroupA | INTEGER (1..64) |

| | |
|---|---|
| } | OPTIONAL, |

-- Need R

| | |
|---|---|
| ra-ContentionResolutionTimer | ENUMERATED { sf8, sf16, sf24, |

sf32, sf40, sf48, sf56, sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |
| l839 | INTEGER (0..837), |
| l139 | INTEGER (0..137), |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, |

restrictedSetTypeA, restrictedSetTypeB},

| | |
|---|---|
| msg3-transformPrecoder | ENUMERATED {enabled} |

```
OPTIONAL, -- Need R
...,
  [[
  ra-PrioritizationForAccessIdentity-r16 SEQUENCE {
```

| | |
|---|---|
| ra-Prioritization-r16 | RA-Prioritization, |
| ra-PrioritizationForAI-r16 | BIT STRING (SIZE (2)) |

| | |
|---|---|
| } | OPTIONAL, |

-- Cond InitialBWP-Only

| | |
|---|---|
| prach-RootSequenceIndex-r16 | CHOICE { |
| l571 | INTEGER (0..569), |
| l1151 | INTEGER (0..1149) |

```
  } OPTIONAL -- Need R
  ]],
  [[
```

| | |
|---|---|
| ra-PrioritizationForSlicing-r17 | RA-PrioritizationForSlicing-r17 |

OPTIONAL, -- Cond InitialBWP-Only

| | |
|---|---|
| featureCombinationPreamblesList-r17 | SEQUENCE |

(SIZE(1..maxFeatureCombPreamblesPerRACHResource-r17)) OF
FeatureCombinationPreambles-r17 OPTIONAL -- Cond AdditionalRACH
]]
}
-- TAG-RACH-CONFIGCOMMON-STOP
featureCombinationPreamblesList
Specifies a series of preamble partitions each associated to a combination of
features and 4-step RA. The network does not configure this list to have more
than 32 entries.
messagePowerOffsetGroupB
Threshold for preamble selection. Value is in dB. Value minusinfinity
corresponds to −infinity. Value dB0 corresponds to 0 dB, dB5 corresponds to 5
dB and so on (see TS 38.321 [3], clause 5.1.2). This field is set to the same value
for different repetition numbers associated with a specific FeatureCombination.
msg1-SubcarrierSpacing
Subcarrier spacing of PRACH (see TS 38.211 [16], clause 5.3.2).
Only the following values are applicable depending on the used frequency:
FR1: 15 or 30 kHz
FR2-1: 60 or 120 kHz
FR2-2: 120, 480, or 960 kHz
If absent, the UE applies the SCS as derived from the prach-ConfigurationIndex
in RACH-ConfigGeneric (see tables Table 6.3.3.1-1, Table 6.3.3.1-2, Table
6.3.3.2-2 and Table 6.3.3.2-3, TS 38.211 [16]). The value also applies to
contention free random access (RACH-ConfigDedicated), to SI-request and to
contention-based beam failure recovery (CB-BFR). But it does not apply for
contention free beam failure recovery (CF-BFR) (see
BeamFailureRecoveryConfig).
msg3-transformPrecoder
Enables the transform precoder for Msg3 transmission according to clause
6.1.3 of TS 38.214 [19]. If the field is absent, the UE disables the transformer
precoder (see TS 38.213 [13], clause 8.3).
numberOfRA-PreamblesGroupA
The number of CB preambles per SSB in group A. This determines implicitly
the number of CB preambles per SSB available in group B. (see TS 38.321
[3], clause 5.1.1). The setting should be consistent with the setting of ssb-
perRACH-OccasionAndCB-PreamblesPerSSB.
prach-RootSequenceIndex
PRACH root sequence index (see TS 38.211 [16], clause 6.3.3.1). The value
range depends on whether L = 839 or L = 139 or L = 571 or L = 1151. The length
of the root sequence corresponding with the index indicated in this IE should
be consistent with the one indicated in prach-ConfigurationIndex in the
RACH-ConfigDedicated (if configured). If prach-RootSequenceIndex-r16 is
signalled, UE shall ignore the prach-RootSequenceIndex (without suffix).
For FR2-2, only the following values are applicable depending on the used
subcarrier spacing:
120 kHz: L = 139, L = 571, and L = 1151
480 kHz: L = 139, and L = 571
960 kHz: L = 139
ra-ContentionResolutionTimer
The initial value for the contention resolution timer (see TS 38.321 [3], clause
5.1.5). Value sf8 corresponds to 8 subframes, value sf16 corresponds to 16
subframes, and so on.
ra-Msg3SizeGroupA
Transport Blocks size threshold in bits below which the UE shall use a
contention-based RA preamble of group A (see TS 38.321 [3], clause 5.1.2).
This field is set to the same value for different repetition numbers associated
with a specific FeatureCombination.
ra-Prioritization
Parameters which apply for prioritized random access procedure on any UL
BWP of SpCell for specific Access Identities (see TS 38.321 [3], clause
5.1.1a).
ra-PrioritizationForAI
Indicates whether the field ra-Prioritization-r16 applies for Access Identities.
The first/leftmost bit corresponds to Access Identity 1, the next bit
corresponds to Access Identity 2. Value 1 indicates that the field ra-
Prioritization-r16 applies otherwise the field does not apply (see TS 23.501
[32]).
ra-PrioritizationForSlicing
Parameters which apply to configure prioritized CBRA 4-step random access
type for slicing.
rach-ConfigGeneric
RACH parameters for both regular random access and beam failure recovery.
restrictedSetConfig
Configuration of an unrestricted set or one of two types of restricted sets, see
TS 38.211 [16], clause 6.3.3.1.
rsrp-ThresholdSSB
UE may select the SS block and corresponding PRACH resource for path-loss
estimation and (re)transmission based on SS blocks that satisfy the threshold
(see TS 38.213 [13]).
rsrp-ThresholdSSB-SUL
The UE selects SUL carrier to perform random access based on this threshold
(see TS 38.321 [3], clause 5.1.1). The value applies to all the BWPs and all
RACH configurations.
ssb-perRACH-OccasionAndCB-PreamblesPerSSB
The meaning of this field is twofold: the CHOICE conveys the information
about the number of SSBs per RACH occasion. Value oneEighth corresponds
to one SSB associated with 8 RACH occasions, value oneFourth corresponds
to one SSB associated with 4 RACH occasions, and so on. The
ENUMERATED part indicates the number of Contention Based preambles
per SSB. Value n4 corresponds to 4 Contention Based preambles per SSB,
value n8 corresponds to 8 Contention Based preambles per SSB, and so on.
The total number of CB preambles in a RACH occasion is given by CB-
preambles-per-SSB * max(1, SSB-per-rach-occasion). See TS 38.213 [13].
totalNumberOfRA-Preambles
Total number of preambles used for contention based and contention free 4-
step or 2-step random access in the RACH resources defined in RACH-
ConfigCommon, excluding preambles used for other purposes (e.g. for SI
request). If the field is absent, all 64 preambles are available for RA. The
setting should be consistent with the setting of ssb-perRACH-
OccasionAndCB-PreamblesPerSSB, i.e. it should be a multiple of the number
of SSBs per RACH occasion.

| Conditional | |
|---|---|
| Presence | Explanation |
| AdditionalRACH | The field is mandatory present if the RACH- |
| | ConfigCommon is included in an AdditionalRACH- |
| | Config. When included in initialUplinkBWP-RedCap to |
| | indicate other feature(s) than redcap and eRedCap, this |
| | field is mandatory present with at least |
| | FeatureCombinationPreambles list entries: the list |
| | entry/entries indicating only redcap or eRedCap and |
| | the other(s) indicating both redcap or eRedCap and one |
| | or multiple other feature(s) (e.g., smallData, nsag or |
| | msg3-Repetitions). |
| | Otherwise, it is optional, Need R. |
| InitialBWP-Only | This field is optionally present, Need R, if this BWP is |
| | the initial BWP of SpCell. Otherwise, the field is |
| | absent. |
| L139 | The field is mandatory present if prach- |
| | RootSequenceIndex L = 139, otherwise the field is |
| | absent, Need S. |
| SUL | The field is mandatory present in rach-ConfigCommon |
| | in initialUplinkBWP if supplementaryUplink is |
| | configured in ServingCellConfigCommonSIB or if |
| | supplementaryUplinkConfig is configured in |
| | ServingCellConfigCommon; otherwise, the field is |
| | absent. This field is not configured in additionalRACH- |
| | Config. |

The introduction of PRACH preamble repetition transmissions is being considered to enhance UL coverage in the existing NR system. Therefore, to support PRACH repetition, it is necessary to define how to allocate PRACH resources different repetition transmission numbers. Accordingly, the present disclosure proposes a RACH resource partitioning method and related UE/base station operations when PRACH repetition is introduced in the NR system.

A method of allocating RACH resources for multiple PRACH repetitions is described below.

Multiple methods of allocating PRACH repetition resources different repetition numbers are being considered. In this instance, a method may be considered to allocate RACH resources so that multiple PRACH repetition resources different repetition numbers are distinguished based on a preamble level or an RO level, and related methods are proposed as follows.

### [Method 1]

A method of allocating multiple PRACH repetition resources with different repetition numbers in a separated RO scheme based on additional RACH configuration is described below.

A. A base station may configure/indicate a repetition number as follows. The repetition number may be configured/indicated based on RACH-commonconfig or FeatureCombinationPreambles. For example, a parameter (e.g., RACH-commonconfig) in each additional RACH configuration (e.g., AdditionalRACH-Config-r17) may include the repetition number. For example, RACH partitioning (e.g., FeatureCombinationPreambles) in RACH-commonconfig may include the repetition number.
i. As a specific example, the configured/indicated repetition number may be one of {1, 2, 4, 8}. A UE may perform single or multiple RACH transmission based on the repetition number configured/indicated by the base station.
ii. For another example, the configured/indicated repetition number may be one of {2, 4, 8}. If the base station does not configure/indicate the repetition number, the repetition number may be implicitly indicated as 1. For example, the UE may perform the multiple RACH transmissions based on the repetition number configured/indicated by the base station. If the repetition number is not indicated by the base station (e.g., there is no value indicated by the repetition number or there is no repetition number parameter), the UE may perform the single RACH transmission.

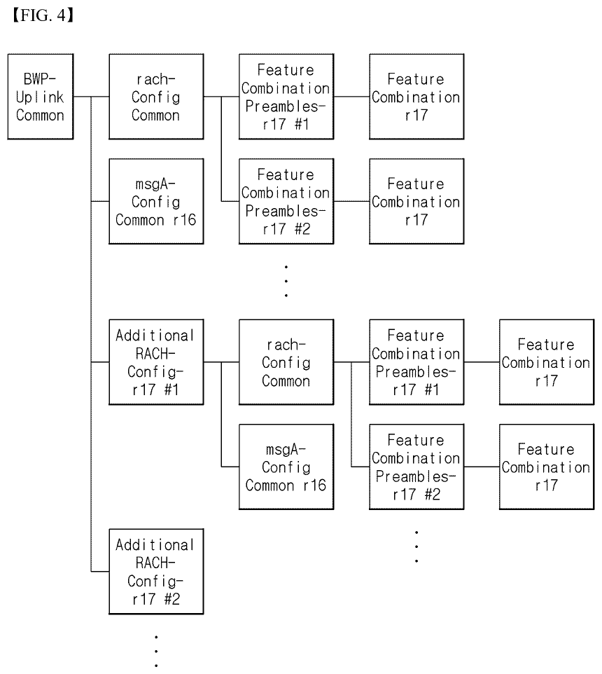

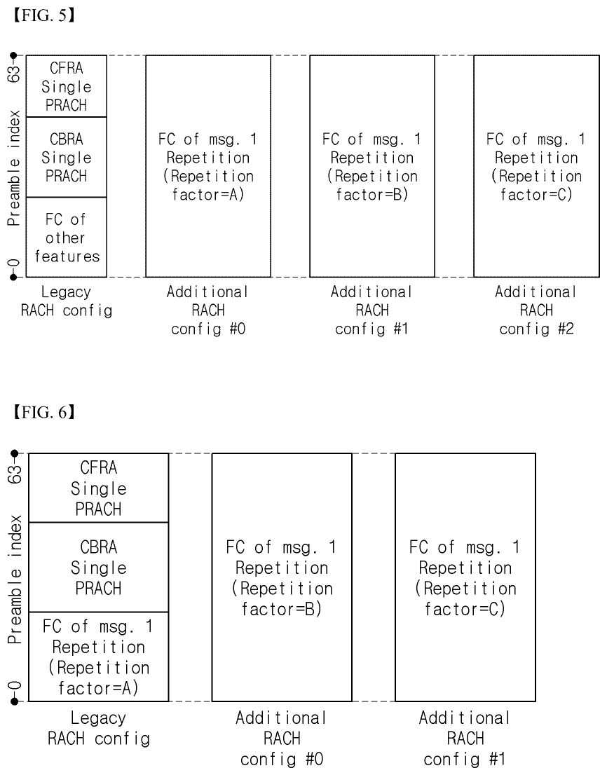

Configuration of the repetition number is described below in detail with reference to FIGS. 5 to 9.

FIGS. 5 to 9 illustrate configuration of a repetition number based on additional RACH configuration.

### Alt 1-1)

Each of additional RACH configurations that configure/indicate multiple RACH transmissions may be defined to always indicate a different repetition number.
i. It may be assumed that a base station allocates a single RACH resource and multiple RACH resources based on a separated RO scheme. That is, if the legacy RACH configuration does not indicate a repetition number, the repetition number (repetition factor) may be allocated as illustrated in FIG. 5. Referring to FIG. 5, a repetition number based on each AdditionalRACHconfig is A, B, or C. FC represents a feature combination. For example, the UE may perform a RACH procedure by selecting a RACH configuration that matches a repetition number determined based on RSRP. For example, the repetition number may be determined as 2, 4, or 8 based on the RSRP being lower than a RSRP threshold (for repetition number 2/4/8).
ii. It may be assumed that the base station allocates a single RACH resource and multiple RACH resources based on the separated RO scheme. That is, if the legacy RACH configuration also indicates a repetition number, the following embodiment may be applied.

### Alt 1-1-1)

As illustrated in FIG. 6, the repetition number indicated in the legacy RACH configuration may be defined to always be configured/indicated differently from the repetition number values indicated in the additional RACH configurations. Referring to FIG. 6, the repetition number based on the legacy RACH configuration is A, and the repetition number based on each AdditionalRACHconfig is B or C. For example, the UE may perform the RACH procedure by selecting a RACH configuration that matches a repetition number determined based on RSRP. For example, the repetition number may be determined as 2, 4, or 8 based on the RSRP being lower than the RSRP threshold (for repetition number 2/4/8).

### Alt 1-1-2)

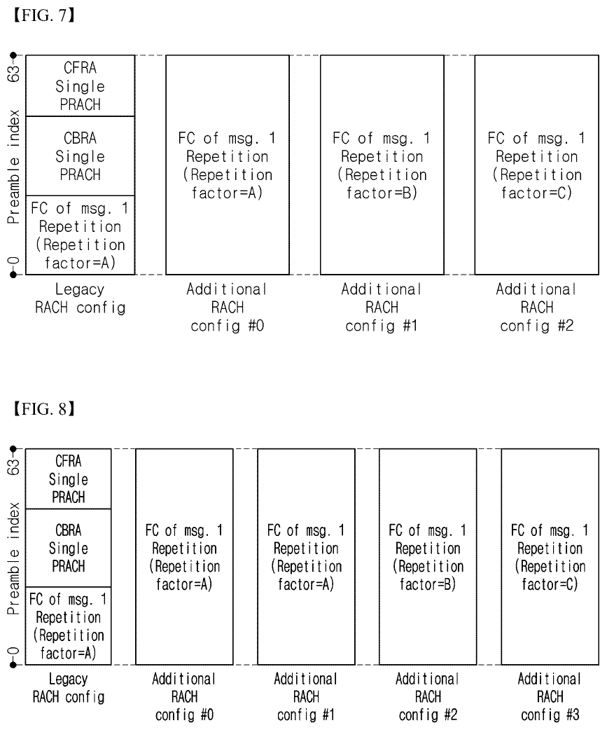

As illustrated in FIG. 7, only the repetition number value indicated based on each additional RACH configuration may be defined to be differently configured/indicated, regardless of the repetition number value indicated in the legacy RACH configuration.
A. If there are two RACH resources with the same repetition number (e.g., if a legacy RACH configuration and a specific additional RACH configuration have the same repetition number), and if it is determined that the UE selects the corresponding repetition number through RSRP, etc., the following embodiment may be applied.

### Alt 1-1-2-A)

The UE may select a RACH resource based on a configured/indicated/defined probability value. For example, the probability value may be configured/indicated/defined as follows.
p=legacy RACH configuration selection probability
1−p=additional RACH configuration selection probability (0<p≤1)

### Alt 1-1-2-B)

The UE may randomly select a RACH resource.

### Alt 1-2)

The same repetition number may be configured/indicated based on two or more additional RACH configurations and/or a legacy RACH configuration.

i. There may be two RACH resources with the same repetition number (e.g., if repetition numbers based on a legacy RACH configuration and/or multiple additional RACH configurations are the same). Specifically, referring to FIG. 8, a repetition number based on each of Legacy RACH config, Additional RACH config #0, and Additional RACH config #1 is A. If the UE is determined to select the repetition number through the RSRP, etc., the following embodiment may be applied.

### Alt 1-2-A)

The UE may select a RACH resource based on a configured/indicated/defined probability value. For example, the probability value may be configured/indicated/defined as follows.
p=legacy RACH configuration selection probability
(1−p)/N=selection probability of one of N additional RACH configurations (0≤p≤1)

### Alt 1-2-B)

The UE may randomly select a RACH resource.

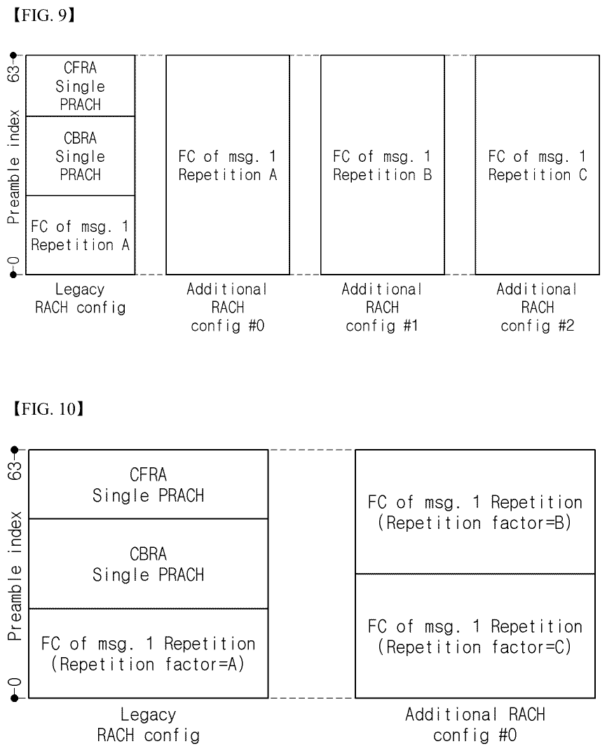

A method of setting a parameter for feature combination is described in detail below.
i. Alt A) Parameters for feature combination may be set to a common value for Msg. 1 repetition, regardless of the repetition number. For example, a new parameter may be introduced (e.g., msg. 1 repetition R18). For example, existing parameters (e.g., msg. 3 repetition R17) may be reused to support up to PRACH repetition.
ii. Alt B) As illustrated in FIG. 9, parameters for feature combination may be set to a different parameter per repetition number. For example, the parameter for feature combination may be defined to include a repetition number value (e.g., msg. 1 Repetition A, msg. 1 Repetition B, msg. 1 Repetition C). According to the present embodiment, the base station does not need to separately indicate the repetition number value in the RACH configuration, but multiple parameters for feature combination shall be set.

For example, a different feature may be introduced for each repetition number (e.g., R=A, B, C) as shown in Table 8 below (in this case, A, B, and C may be one of 2, 4, and 8).

TABLE 8
FeatureCombination-r17 ::= SEQUENCE {

| | |
|---|---|
| redCap-r17 | ENUMERATED {true} OPTIONAL, -- Need R |
| smallData-r17 | ENUMERATED {true} OPTIONAL, -- Need R |
| nsag-r17 | NSAG-List-r17 OPTIONAL, -- Need R |
| msg3-Repetitions-r17 | ENUMERATED {true} OPTIONAL, -- Need R |
| msg1-RepetitionsA-r18 | ENUMERATED {true} OPTIONAL, -- Need R |
| msg1-RepetitionsB-r18 | ENUMERATED {true} OPTIONAL, -- Need R |
| msg1-RepetitionsC-r18 | ENUMERATED {true} OPTIONAL, -- Need R |
| spare4 | ENUMERATED {true} OPTIONAL, -- Need R |

}

As described above, the base station may configure/indicate PRACH resource partitioning corresponding to each repetition number to the UE through a feature combination method, in a state in which the repetition numbers are configured to different features.

Characteristically, the UE may expect that multiple RACH partitionings, each including multiple PRACH features with different repetition numbers, will not be configured within a specific additional RACH configuration. If the multiple RACH partitionings are configured, the UE may determine the configuration to be invalid.

Additionally, the UE may expect that RACH partitioning consisting of feature combinations between multiple PRACH features with different repetition numbers will not be configured within a specific additional RACH configuration. If such a configuration is configured, the UE may determine the configuration to be invalid.

When different repetition numbers are allocated in the separated RO scheme, the probability of collision between UEs using a specific repetition number can be reduced compared to when different repetition numbers are allocated in a separated preamble in shared RO scheme.

### [Method 2]

A method of allocating multiple PRACH repetition resources with different repetition numbers in a separated preamble in shared RO scheme based on a feature combination method is described below.

A. It is necessary to define the multiple PRACH repetition resources to be distinguished within a specific RACH configuration based on a preamble level so as to allocate the different repetition numbers in the separated preamble in shared RO scheme.

### Alt 2-1)

A method may be considered in which parameters for feature combination are set to be common for msg. 1 repetition, regardless of the repetition number.

According to the related art, allocation of multiple RACH partitionings with the same feature or feature combination within a specific RACH configuration is not supported.

### Alt 2-1-1)

If allocation of multiple RACH partitionings with the same feature or feature combination within a specific RACH configuration is supported in Rel-18 CE, the following embodiments may be applied.

### Alt 2-1-1-1)

The base station may configure/indicate a different repetition number for each RACH partitioning corresponding to a PRACH repetition feature (e.g., Msg. 1 Repetition R18) and/or a feature combination including the feature.
A. That is, as illustrated in FIG. 10, a different repetition number may be configured for each RACH partitioning (e.g., FeatureCombinationPreambles). Each RACH partitioning (e.g., FeatureCombinationPreambles) may be based on FeatureCombinationPreambles included in each RACH-commonconfig (e.g., each rach-ConfigcCommon in FIG. 4). Referring to FIG. 4, the RACH-commonconfig may include i) FeatureCombinationPreambles based on legacy RACH configuration (rach-ConfigCommon based on BWP-UplinkCommon) and/or ii) FeatureCombinationPreambles based on each AdditionalRACH-Config.
i. In this instance, a PRACH repetition feature (e.g., Msg. 1 Repetition R18) and/or a feature combination including the feature may be configured based on the RACH partitioning (e.g., FeatureCombinationPreambles).

### Alt 2-1-1-2)

The base station may randomly configure/indicate a repetition number for each RACH partitioning corresponding to a PRACH repetition feature (e.g., Msg. 1 Repetition R18) and/or a feature combination including the feature. That is, the base station may configure/indicate the same repetition number to the RACH partitionings.
A. That is, as illustrated in FIG. 11, a (random) repetition number may be configured/indicated for each RACH partitioning (e.g., FeatureCombinationPreambles). That is, the random repetition number may mean that it is not limited to different repetition numbers, unlike the Alt 2-1-1-1). For example, a repetition number (A) configured based on a RACH partitioning (e.g., RACH partitioning based on Legacy RACH config in FIG. 11) may be the same as a repetition number (A) configured based on another RACH partitioning (e.g., RACH partitioning based on Additional RACH Config #0 in FIG. 11).

Each RACH partitioning (e.g., FeatureCombinationPreambles) may be based on FeatureCombinationPreambles included in each RACH-commonconfig (e.g., each rach-ConfigcCommon of FIG. 4). Referring to FIG. 4, the RACH-commonconfig may include i) FeatureCombinationPreambles based on legacy RACH configuration (rach-ConfigCommon based on BWP-UplinkCommon) and/or ii) FeatureCombinationPreambles based on each AdditionalRACH-Config.
i. In this instance, a PRACH repetition feature (e.g., Msg. 1 Repetition R18) and/or a feature combination including the feature may be configured based on the RACH partitioning (e.g., FeatureCombinationPreambles).

The following embodiments may be applied in relation to the selection of the RACH partitioning.

### Alt 2-1-1-2-A)

The UE may select a RACH partitioning based on a configured/indicated/defined probability value. For example, the probability value may be configured/indicated/defined as follows.
p/M=selection probability of one of M partitionings in legacy RACH configuration
(1−p)/N=selection probability of one of N partitionings in additional RACH configuration

### Alt 2-1-1-2-B)

The UE may randomly select a RACH partitioning.

### Alt 2-1-2)

If (the existing method is maintained and) allocation of multiple RACH partitionings with the same feature or feature combination within a specific RACH configuration is not supported, the following embodiments may be applied.

### Alt 2-1-2-1)

A method of dividing a preamble index section (i.e., starting preamble index and/or the number of preamble indices) per repetition number based on a predefined equation may be considered.
A. The base station may configure/indicate one or multiple repetition numbers to the UE via higher layer signaling (e.g., SIB1, etc.).

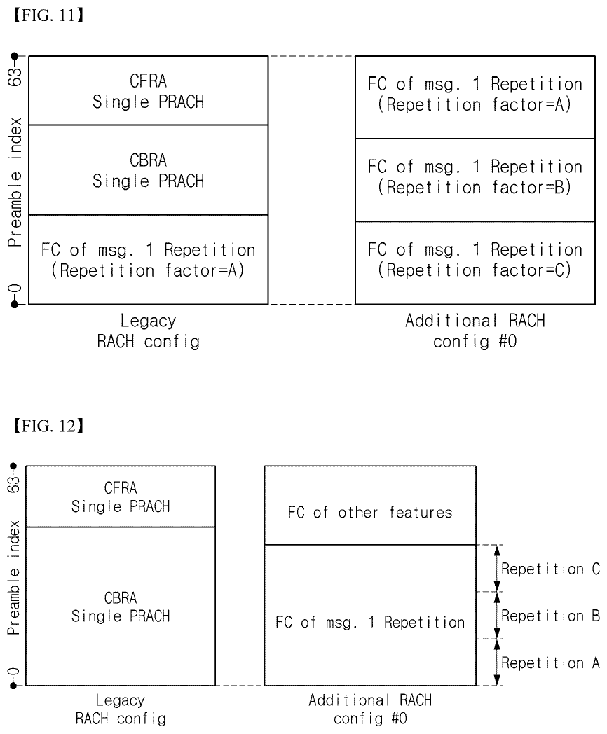

Characteristically, the repetition numbers may be configured/indicated based on parameters (e.g., RACH-commonconfig) for legacy RACH configuration and/or additional RACH configuration.
B. One RACH partitioning corresponding to a PRACH repetition feature (e.g., Msg. 1 Repetition R18) and/or a feature combination including the feature may be assigned. A preamble index may be (evenly) divided based on a predefined equation depending on the number of repetition numbers indicated via higher layer signaling (e.g., SIB1, etc.) and their values.
i. For example, it may be assumed that a total of K repetition numbers (e.g., K=3, R={A, B, C}) are indicated based on higher layer signaling (e.g., SIB1, etc.), and the total number of preamble indices assigned to RACH partitioning corresponding to the PRACH repetition feature (e.g., Msg. 1 Repetition R18) is L. In this case, the repetition number may be configured/assigned as illustrated in FIG. 12. This is described in detail below.
1. Among the preamble indices assigned to the RACH partitioning, ceil (L/K) preamble indices starting from a lowest preamble index may be defined for repetition number A.
2. Among the preamble indices assigned to the RACH partitioning, ceil (L/K) preamble indices starting from (lowest index+ceil (L/K)) preamble index may be defined for repetition number B.
3. Among the preamble indices assigned to the RACH partitioning, ceil (L/K) preamble indices starting from (lowest index+2*ceil (L/K)) preamble index may be defined for repetition number C.

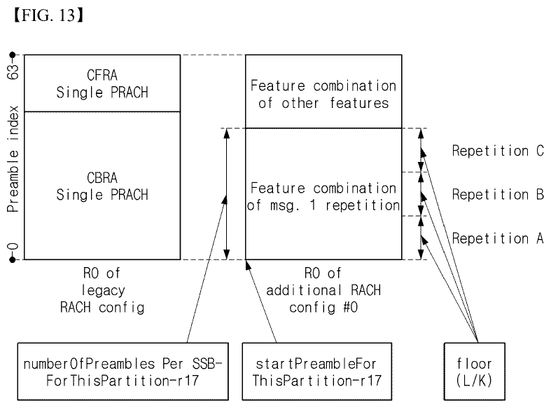

If the ceil (L/K) preamble indices starting from the (lowest index+2*ceil (L/K)) preamble index are selected for the repetition number C, but the number of the selected preamble indices exceeds L preamble indices assigned by the base station, the exceeding preamble indices may be configured not to be used.
ii. For another example, it may be assumed that a total of K repetition numbers (e.g., K=3, R={A, B, C}) are indicated based on higher layer signaling (e.g., SIB1, etc.), and the total number of preamble indices assigned to RACH partitioning corresponding to the PRACH repetition feature (e.g., Msg. 1 Repetition R18) through startPreambleForThisPartition-r17 and/or numberOfPreamblesPerSSB-ForThisPartition-r17 is L. In this case, the repetition number may be configured/assigned as illustrated in FIG. 13. This is described in detail below.
1. Among the preamble indices assigned to the RACH partitioning, floor (L/K) preamble indices starting from a lowest preamble index (e.g., startPreambleForThisPartition-r17) may be defined for repetition number A.
2. Among the preamble indices assigned to the RACH partitioning, floor (L/K) preamble indices starting from (lowest index+floor (L/K)) preamble index may be defined for repetition number B.
3. Among the preamble indices assigned to the RACH partitioning, floor (L/K) preamble indices starting from (lowest index+2*floor (L/K)) preamble index may be defined for repetition number C.

If any of L preamble indices is not selected for any repetition number purpose after up to the floor (L/K) preamble indices starting from the (lowest index+2*floor (L/K)) preamble index are determined for the repetition number C, the following operation/configuration may be applied.

For example, the preamble indices may be configured not to be used for repetition transmissions.

For example, the preamble indices may be configured to use the largest (or smallest) repetition number configured by the base station for the RO, or the preamble indices for the repetition number C in the above example.
iii. For another example, a method of distributing the number of preamble indices more fairly across repetition numbers may be considered. The following case may be assumed.

The base station indicates a total of K repetition numbers (e.g., K=3, R={A, B, C}) based on higher layer signaling (e.g., SIB1, etc.). The total number of preamble indices assigned to RACH partitioning corresponding to the PRACH repetition feature (e.g., Msg. 1 Repetition R18) through startPreambleForThisPartition-r17 and/or numberOfPreamblesPerSSB-ForThisPartition-r17 is L. Each preamble index is referred to as p_idx (e.g., p_idx=startPreambleForThisPartition-r17, startPreambleForThisPartition-r17+1, startPreambleForThisPartition-r17+2, . . . , startPreambleForThisPartition-r17+L−1).

In the above case, the repetition number may be configured/assigned as follows.
1. Among the preamble indices assigned to the RACH partitioning, preamble indices corresponding to p_idx satisfying mod (p_idx, K)=0 may be defined for repetition number A.
2. Among the preamble indices assigned to the RACH partitioning, preamble indices corresponding to p_idx satisfying mod (p_idx, K)=1 may be defined for repetition number B.
3. Among the preamble indices assigned to the RACH partitioning, preamble indices corresponding to p_idx satisfying mod (p_idx, K)=2 may be defined for repetition number C.

In the above methods, when the number of repetition numbers indicated by the base station based on higher layer signaling (e.g., SIB1, etc.) is K in total (e.g., K=3, R={A, B, C}), the order of A, B, and C may be defined as follows.

For example, the order of A, B, and C may be the order actually indicated by the base station in the corresponding parameter (e.g., 1st, 2nd, 3rd, etc.).

For example, the order of A, B, and C may be the ascending (or descending) order of repetition numbers indicated by the base station.

For example, the order of A, B, and C corresponding to a result {0, 1, 2} of mod (p_idx, K) may be pre-defined (e.g., defined so that the value with the largest value of the repetition number is mapped to the preamble indices corresponding to mod (p_idx, K)=0).

Characteristically, the base station may set the L and K values so that the L/K values are always integers (i.e., so that there is no remaining preamble index using the above method). That is, the base station may indicate the L value as one of the integer multiples of the K value, which is the number of repetition numbers configured/indicated for the corresponding RACH resource.

### Alt 2-1-2-2)

A method of dividing a preamble index section (i.e., starting preamble index and/or the number of preamble indices) per repetition number by introducing additional parameters via higher layer signaling (e.g., SIB1, etc.) may be considered.
A. The base station may configure/indicate one or multiple repetition numbers based on higher layer signaling (e.g., SIB1, etc.). Characteristically, the repetition numbers may be configured/indicated based on parameters (e.g., RACH-commonconfig) for legacy RACH configuration and/or additional RACH configuration.
B. The base station may assign one RACH partitioning corresponding to a PRACH repetition feature (e.g., Msg. 1 Repetition R18) and/or a feature combination including the feature.

If one repetition number is configured/indicated, a preamble section for the repetition number may be configured through the existing parameters (e.g., startPreambleForThisPartition-r17, numberOfPreambles PerSSB-ForThisPartition-r17).

If multiple repetition numbers are configured/indicated, the following operation/configuration may be applied.
i. A preamble section for a lowest (or highest) repetition number may be configured through the existing parameters (e.g., startPreambleForThisPartition-r17, numberOfPreambles PerSSB-ForThisPartition-r17). A preamble section for the remaining repetition numbers may be configured based on the following embodiments.

### Alt 2-1-2-2-1)

Pairs of additional parameters (e.g., additionalstartPreambleForThisPartition-r18, additionalnumberOf PreamblesPerSSB-ForThisPartition-r18) may be configured/indicated as many as the number of remaining repetition numbers, and a preamble section for next repetition numbers may be configured through these.

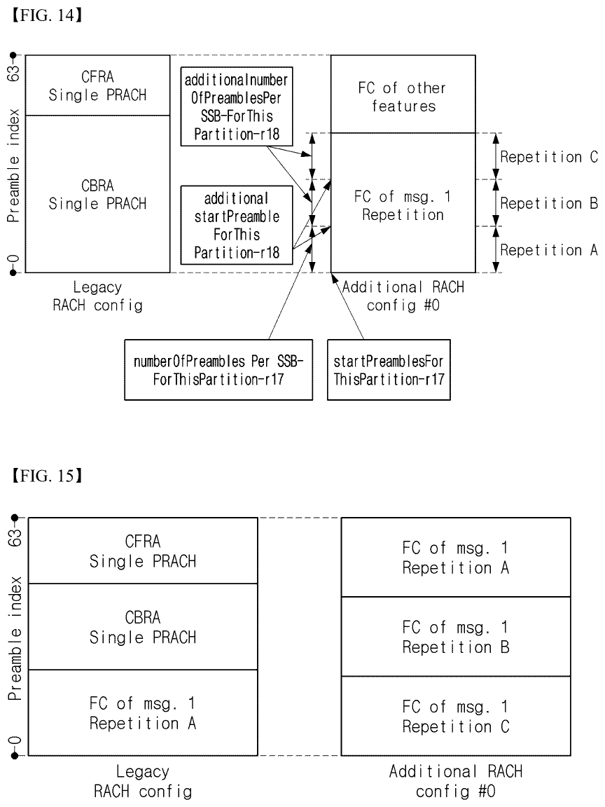

That is, if the total of three repetition numbers (e.g., R={A, B, C}) are indicated, a preamble section for one repetition number (e.g., A) may be configured through the existing parameter as illustrated in FIG. 14, and a preamble section for the remaining repetition numbers (e.g., B, C) may be configured by adding two pairs of additional parameters.

### Alt 2-1-2-2-2)

One or multiple starting preamble offsets may be configured/indicated to assign the remaining repetitions. That is, an offset from a starting index indicated by the existing parameter may be indicated. In this instance, the number of preambles may be additionally indicated as an additional parameter or may be configured/defined to reuse the existing parameter.

### Alt 2-1-2-2-3)

A preamble section for a next repetition number may be configured/defined to start immediately after a preamble section for a previous repetition number ends without additional parameter. In this case, the number of preambles may be separately indicated or may be configured/defined to reuse the existing parameters.
1. In this instance, the existing parameter representing the number of preambles may be defined to be used as an offset of a starting index.
2. Further, the number of preambles may be additionally indicated as an additional parameter, or may be configured to reuse the existing parameter.

In the above methods, the UE may expect that respective preamble sections corresponding to different repetition numbers are configured not to overlap each other.

### Alt 2-2)

A method of configuring parameters for feature combination as different parameters per repetition number may be considered.

For example, as illustrated in FIG. 15, the parameters for feature combination may be defined to include values of the repetition numbers (e.g., msg. 1 Repetition A, msg. 1 Repetition B, msg. 1 Repetition C).

The base station does not need to separately indicate the repetition number value within RACH configuration, but multiple parameters for feature combination shall be configured.

For example, as shown in Table 9, a different feature may be introduced for each repetition number (e.g., R=A, B, C) (where A, B, and C may be one of 2, 4, and 8).

TABLE 9
FeatureCombination-r17 ::= SEQUENCE {

| | |
|---|---|
| redCap-r17 | ENUMERATED {true} OPTIONAL, -- Need R |
| smallData-r17 | ENUMERATED {true} OPTIONAL, -- Need R |
| nsag-r17 | NSAG-List-r17 OPTIONAL, -- Need R |
| msg3-Repetitions-r17 | ENUMERATED {true} OPTIONAL, -- Need R |
| msg1-RepetitionsA-r18 | ENUMERATED {true} OPTIONAL, -- Need R |
| msg1-RepetitionsB-r18 | ENUMERATED {true} OPTIONAL, -- Need R |
| msg1-RepetitionsC-r18 | ENUMERATED {true} OPTIONAL, -- Need R |
| spare4 | ENUMERATED {true} OPTIONAL, -- Need R |

}

As described above, the base station may configure/indicate PRACH resource partitioning corresponding to each repetition number to the UE through a feature combination method, in a state in which the repetition numbers are configured to different features.

Characteristically, the UE may expect that RACH partitioning including feature combinations of multiple PRACH features with different repetition numbers, will not be configured within a specific additional RACH configuration. If the RACH partitioning is configured, the UE may determine the configuration to be invalid.

The above operation may be applied to all legacy RACH configuration and/or Additional RACH configuration.

### [Method 3]

A method of assigning ROs to multiple PRACH repetition resources with different repetition numbers by distinguishing the ROs allocated to the same RACH configuration based on TDM may be considered.
A. A base station may configure/indicate a repetition number as follows. The repetition number may be configured/indicated based on RACH-commonconfig or FeatureCombinationPreambles. For example, a parameter (e.g., RACH-commonconfig) in each additional RACH configuration (e.g., AdditionalRACH-Config-r17) may include the repetition number. For example, RACH partitioning (e.g., FeatureCombinationPreambles) in RACH-commonconfig may include the repetition number.
i. As a specific example, the repetition number indicated by the base station may be multiple among {1, 2, 4, 8}.
ii. For another example, the repetition number indicated by the base station may be one or multiple of {2, 4, 8}. That is, it may be assumed that single transmission is always configured.
B. RO mask parameters as many as the number of repetition numbers indicated by the base station may be configured/indicated based on higher layer signaling (e.g., SIB1, etc.).
i. The RO mask parameter to be configured for each different repetition number may be a parameter with a size equal to the number of TDMed ROs corresponding to an SSB-to-RO mapping period. Through the RO mask parameter, the TDMed ROs corresponding to a specific repetition number may be defined to be expressed/indicated as a bitmap.
1. As a specific example, if the total number of ROs located at different time instances within a specific period (e.g., PRACH configuration period, association (pattern) period, etc.) is N, the size of the RO mask parameter may be set to N bits.

For another example, if the total number of ROs located at different time instances among ROs associated with the same SSB within a specific period (e.g., PRACH configuration period, association (pattern) period, etc.) is M, the size of the RO mask parameter may be set to M bits.
2. If K (2 or more) repetition numbers are configured/indicated in the corresponding RACH configuration, a total of K (2 or more) RO mask parameters may be indicated, and each RO mask parameter may be indicated differently for each repetition number.
3. The UE may determine which RO is used for PRACH repetition transmission (or included in an RO group for repetition transmission) based on the N-bit (or M-bit) bitmap, and may perform the repetition transmission using this.
4. In this instance, the UE may expect that the locations of the ROs indicated by the RO mask parameters configured for different repetition numbers will be allocated without overlapping each other on the time domain.
ii. Characteristically, the RO mask parameter for repetition number 1 is not separately introduced, and the remaining ROs that are not indicated by the RO mask parameters for the repetition numbers greater than or equal to 2 may be configured/defined as ROs for single PRACH transmission.
iii. Based on the RO mask parameters for each repetition number configured/indicated by the base station, candidate ROs may be configured/indicated to the UE. The UE may perform the RACH procedure (or configure an RO group) by selecting, as many as the repetition number, ROs corresponding to an UL beam that the UE intends to transmit (i.e., ROs associated with an SSB index selected by the UE) based on the SSB-to-RO mapping among the candidate ROs.
C. It may be assumed that a specific preamble index section is configured/defined by a PRACH repetition feature (e.g., Msg. 1 Repetition R18) and/or a feature combination including the feature through RACH partitioning. The RACH partitioning may only be applied to ROs configured/indicated through the RO mask parameters for the repetition numbers greater than or equal to 2.
i. That is, ROs that are not selected through the RO mask parameters for the repetition numbers greater than or equal to 2 may be defined as allowing the UE to use the corresponding preamble index section for single RACH transmission purpose, ignoring the RACH partitioning configured/defined by the PRACH repetition feature (e.g., Msg. 1 Repetition R18) and/or the feature combination including the feature.

The proposed methods can be configured/applied to other UL signals/channels such as MSG3 PUSCH, MSGA Preamble/PUSCH and/or PUSCH/PUCCH. Characteristically, the proposed UE/base station operations for PRACH repetition can also be configured/applied as UE/base station operations for other newly introduced features (e.g., repetition transmission features of Msg. 4 HARQ ACK PUCCH). For example, the feature for PUCCH repetition (e.g., pucch-Repetitions-r18) can be configured/applied instead of the feature for the proposed PRACH repetition, and the feature for PUCCH repetition can also be used for the proposed combination method and a method that the UE does not expect. Furthermore, when UE/base station operations for PRACH repetition and/or PUCCH repetition are supported simultaneously, the proposed methods can be configured/applied to all the two channels.

Since examples of the proposed methods described above can also be included as one of the implementation methods of the present disclosure, it is obvious that they can be considered as a kind of proposed methods. In addition, the proposed methods described above can be implemented independently, but can also be implemented in the form of a combination (or merge) of some proposed methods. Information on whether the proposed methods are applied (or information on rules of the proposed methods) may be defined as a rule so that the base station informs the UE via a predefined signal (e.g., a physical layer signal or a higher layer signal). For example, the higher layer may include one or more of functional layers such as MAC, RLC, PDCP, RRC, and SDAP.

Methods, embodiments, or descriptions for implementing the methods proposed in the present disclosure can be applied separately, or one or more methods (or embodiments or descriptions) can be applied in combination.

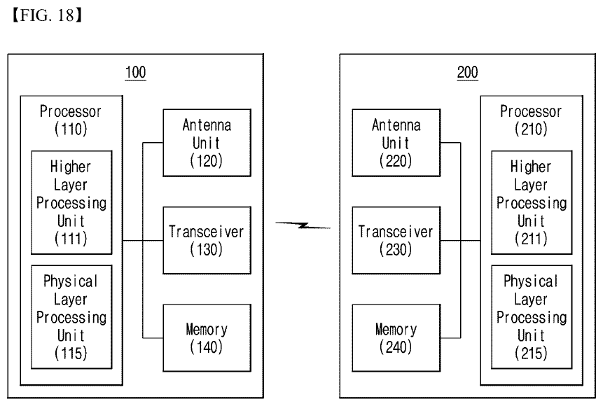

From an implementation perspective, operations of a base station/UE according to the above-described embodiments (e.g., operations based on at least one of the methods 1 to 3) can be processed by a device (e.g., processors 110 and 210 of FIG. 18) of FIG. 18 described below.

Further, the operations of the base station/UE according to the above-described embodiments (e.g., operations based on at least one of the methods 1 to 3) can be stored in a memory (e.g., memories 140 and 240 of FIG. 18) in the form of commands/programs (e.g., instructions, executable codes) for running at least one processor (e.g., processors 110 and 210 of FIG. 18).

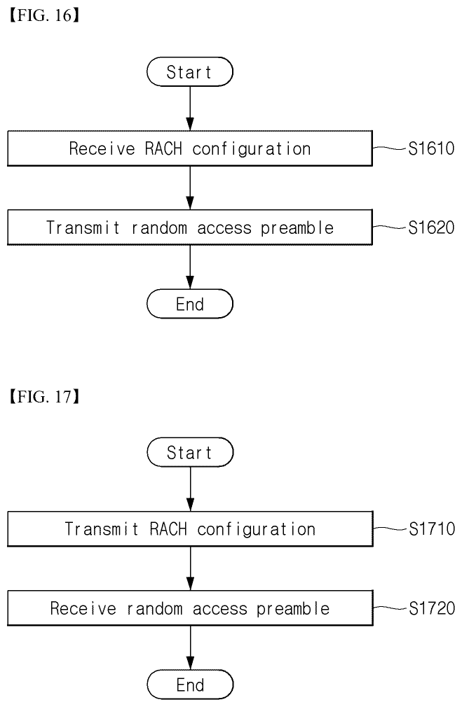

Below, the above-described embodiments are described in detail from a UE and base station operation perspective with reference to FIGS. 16 and 17. Methods described below are merely distinguished for convenience of explanation. Thus, it is obvious that partial configuration of any method can be substituted or combined with partial configuration of another method.

FIG. 16 is a flowchart illustrating a method performed by a user equipment (UE) according to an embodiment of the present disclosure.

Referring to FIG. 16, a method performed by a user equipment (UE) according to an embodiment of the present disclosure includes a step S1610 of receiving RACH configuration and a step S1620 of transmitting a random access preamble.

In the step S1610, the UE receives a random access channel (RACH) configuration from a base station.

In the step S1620, the UE transmits a random access preamble to the base station based on a repetition number related to a feature combination.

For example, the random access preamble may be transmitted based on Table 1. Specifically, transmitting the random access preamble based on the repetition number may mean that random access preamble transmission based on one RACH occasion (RO) is performed multiple times. Therefore, repetition transmission of the random access preamble may mean PRACH transmission based on multiple ROs. In this instance, the multiple ROs may be related to the same synchronization signal/physical broadcast channel (SS/PBCH) block index.

According to an embodiment, the RACH configuration (e.g., RACH-ConfigCommon) may include a plurality of preamble configurations. Each of the plurality of preamble configurations may be related to one feature combination. The repetition number may be one of a plurality of repetition numbers based on the plurality of preamble configurations. The present embodiment may be based on the Alt 2-1-1) of the method 2.

For example, the RACH configuration may include RACH configurations based on a bandwidth part (BWP)-uplink common configuration. The BWP-uplink common configuration may be based on BWP-UplinkCommon described with reference to FIG. 4 and Table 7. Specifically, the RACH configurations may include i) a RACH configuration in the BWP-uplink common configuration and ii) a RACH configuration based on each additional RACH configuration in the BWP-uplink common configuration. Each additional RACH configuration may be based on AdditionalRACH-Config-r17 of FIG. 4 and Table 7.

Each preamble configuration (e.g., FeatureCombinationPreambles) based on the RACH configurations may include information for a set of preambles. On a bandwidth part (BWP), a set of preambles associated with each of the multiple repetition numbers may be at most one. That is, the multiple repetition numbers may be based on different values. The BWP may be configured based on the BWP-uplink common configuration.

For example, the multiple repetition numbers may be related to a shared RACH occasion (RO).

For example, the repetition number may be 2, 4 or 8.

For example, one or more features may be indicated based on the feature combination. The one or more features may include MSG1 repetitions. The multiple repetition numbers may be configured based on preamble configurations including a feature combination related to the MSG1 repetitions. More specifically, the multiple repetition numbers may be configured based on the preamble configurations including the feature combination related to the MSG1 repetitions among the preamble configurations based on the RACH configurations.

According to an embodiment, the repetition number may be determined based on a reference signal received power (RSRP) among the multiple repetition numbers. For example, based on the RSRP being lower than an RSRP threshold, a repetition number applicable to a random access procedure among the multiple repetition numbers may be determined. As a specific example, the RSRP threshold may be defined/configured for each repetition number. Based on the RSRP being lower than an RSRP threshold for a specific repetition number (e.g., 2, 4 or 8), the repetition number may be determined as the specific repetition number among the multiple repetition numbers (e.g., 2, 4, 8).

The operations based on the steps S1610 and S1620 described above may be implemented by a device of FIG. 18. For example, a UE 200 may control one or more transceivers 230 and/or one or more memories 240 so as to perform the operations based on the steps S1610 and S1620. Below, the above-described embodiments are described in detail from a perspective of base station operation.

Steps S1710 and S1720 described below correspond to the steps S1610 and S1620 described with reference to FIG. 16. Considering the above correspondence, redundant description is omitted. That is, the detailed description of the base station operation described below can be replaced with the description/embodiment of FIG. 16 corresponding to the base station operation. For example, the description/embodiment of the steps S1610 and S1620 of FIG. 16 may be additionally applied to the base station operation of the steps S1710 and S1720 described below.

FIG. 17 is a flowchart illustrating a method performed by a base station according to another embodiment of the present disclosure.

Referring to FIG. 17, a method performed by a base station according to another embodiment of the present disclosure includes a step S1710 of transmitting RACH configuration and a step S1720 of receiving a random access preamble.

In the step S1710, the base station transmits a random access channel (RACH) configuration to a UE.

In the step S1720, the base station receives a random access preamble from the UE based on a repetition number related to a feature combination.

The operations based on the steps S1710 and S1720 described above may be implemented by a device of FIG. 18. For example, a base station 100 may control one or more transceivers 130 and/or one or more memories 140 so as to perform the operations based on the steps S1710 and S1720.

The operations/terms based on the above-described embodiments have been described assuming the 5G system. However, this is merely for convenience of explanation and is not intended to limit the scope of application of the technical problem and the problem solution to be solved by the present disclosure to a specific system. That is, the technical challenges/technical issues/problems mentioned in the present disclosure may equally exist in other systems (e.g., 6G system). It is obvious that embodiments of the present disclosure can be extended and applied to solve the same problems in the other systems. Therefore, for expanded application of embodiments of the present disclosure to other systems, terms defined/described based on the 5G system can be replaced/changed with terms defined in the other systems (or generalized terms not specific to one system).

A device to which an embodiment of the present disclosure is applicable (a device implementing the method/operation according to an embodiment of the present disclosure) is described below with reference to FIG. 18.

FIG. 18 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 210 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method comprising:
receiving, by a user equipment (UE), a Random Access CHannel (RACH) configuration,
wherein the RACH configuration includes a plurality of preamble configurations,
wherein each of the plurality of preamble configurations is related to a feature combination; and
transmitting, by the UE, random access preambles with a repetition number which is one of a plurality of repetition numbers based on the plurality of preamble configurations.

2. The method of claim 1, wherein the repetition number is determined based on a Reference Signal Received Power (RSRP) among the plurality of repetition numbers.

3. The method of claim 1, wherein the receiving the RACH configuration comprises: receiving, by the UE, a BandWidth Part (BWP)-uplink common configuration that includes RACH configurations,
wherein the plurality of preamble configurations are based on the RACH configurations.

4. The method of claim 3, wherein the RACH configurations include i) a RACH configuration in the BWP-uplink common configuration and ii) a RACH configuration based on each of one or more additional RACH configurations in the BWP-uplink common configuration.

5. The method of claim 4, wherein each of the plurality of preamble configurations based on the RACH configurations includes information for a set of preambles, and
wherein, on a bandwidth part (BWP), at most one set of preambles is associated with each of the plurality of repetition numbers.

6. The method of claim 5, wherein the plurality of repetition numbers are based on different values.

7. The method of claim 1, wherein one or more features are indicated based on the feature combination, and
wherein the one or more features include MSG1 repetitions.

8. The method of claim 7, wherein the plurality of repetition numbers are configured based on preamble configurations including a feature combination related to the MSG1 repetitions.

9. The method of claim 8, wherein the plurality of repetition numbers are related to a shared RACH occasion (RO).

10. The method of claim 1, wherein the repetition number is 2, 4 or 8.

11. A user equipment (UE) comprising:
one or more transceivers;
one or more processors; and
one or more memories connected to the one or more processors and storing instructions,
wherein the instructions configure the one or more processors to perform, based on being executed by the one or more processors, operations comprising:
receiving a Random Access CHannel (RACH) configuration,
wherein the RACH configuration includes a plurality of preamble configurations,
wherein each of the plurality of preamble configurations is related to a feature combination; and
transmitting random access preambles with a repetition number which is one of a plurality of repetition numbers based on the plurality of preamble configurations.

12. (canceled)

13. (canceled)

14. (canceled)

15. A base station comprising:
one or more transceivers;
one or more processors; and
one or more memories connected to the one or more processors and storing instructions,
wherein the instructions configure the one or more processors to perform, based on being executed by the one or more processors, operations comprising:
transmitting a Random Access CHannel (RACH) configuration,
wherein the RACH configuration includes a plurality of preamble configurations,
wherein each of the plurality of preamble configurations is related to a feature combination; and
receiving random access preambles with a repetition number which is one of a plurality of repetition numbers based on the plurality of preamble configurations.
